(19) United States
(12) Patent Application Publication
(10) Pub. No.: US 2025/0203049 A1
(43) Pub. Date: Jun. 19, 2025

(54) PROJECTION DEVICE AND PROJECTION METHOD

(71) Applicant: HISENSE VISUAL TECHNOLOGY CO., LTD., Qingdao (CN)

(72) Inventors: Gaoming TANG, Qingdao (CN); Xianrong LIU, Qingdao (CN); Lijuan YANG, Qingdao (CN); Jialin LI, Qingdao (CN); Hao WANG, Qingdao (CN); Guohua YUE, Qingdao (CN)

(21) Appl. No.: 19/070,138

(22) Filed: Mar. 4, 2025

Related U.S. Application Data
(63) Continuation of application No. PCT/CN2023/116612, filed on Sep. 1, 2023.

(30) Foreign Application Priority Data
Dec. 12, 2022 (CN) 202211599651.8
Dec. 12, 2022 (CN) 202211614385.1

(51) Int. Cl. H04N 9/31; G03B 17/54; G03B 21/56

(52) U.S. Cl. CPC H04N 9/3123; G03B 17/54; H04N 9/3135; H04N 9/3161; H04N 9/3164; H04N 9/3185; H04N 9/3194; G03B 21/567

(57) ABSTRACT

A projection apparatus includes a projection component, a camera device, and at least one processor in connection with the camera device and the projection component respectively. The at least one processor is configured to execute instructions to cause the display apparatus to: in response to a projection command input from a user, control the projection component to project a first graphic card onto a screen, and obtain a first image taken by the camera device for the first graphic card; cut the first graphic card in the first image to obtain a first graphic card image; perform binarization processing on the first graphic card image, and obtain a white connected region in the first graphic card image based on a binarization result; position a to-be-projected region based on the white connected region; and control the projection component to project a to-be-projected content to the to-be-projected region.

### CROSS-REFERENCE TO RELATED APPLICATIONS

This application is a continuation application of International Application No. PCT/CN2023/116612, filed on Sep. 1, 2023, which claims priorities to Chinese Patent Applications No. 202211599651.8 and 202211614385.1, filed on Dec. 12, 2022, the contents of all of which are hereby incorporated by reference in their entireties.

### TECHNICAL FIELD

The present disclosure relates to the technical field of projection apparatus, and particularly to a projection apparatus and a projection method.

### BACKGROUND

A projection apparatus is a display apparatus that can project an image or video onto a screen. For example, the projection apparatus can be connected with a computer, the Internet, a smart phone, a video signal source and the like, to project a to-be-projected content onto a screen.

In general, the screen has various sizes and types. For different screens, the projection apparatus needs to be adjusted accordingly before projection, to ensure that a to-be-projected image can be more accurately projected onto the screen. For some conventional screens (e.g., four-sided screens), the projection apparatus can easily determine a region where the screen is located, to project the to-be-projected content onto the screen. However, for some non-conventional screens (e.g., two-sided screens), the projection apparatus cannot be able to quickly and accurately determine a position of the screen, affecting the accuracy of the projection of the projection apparatus.

### SUMMARY

Embodiments of the present disclosure provide a projection apparatus, including: a projection component, configured to project a projection content onto a screen; a camera device, configured to take an image of the screen; and at least one processor, in connection with the camera device and the projection component respectively, where the at least one processor is configured to execute instructions to cause the display apparatus to: in response to a projection command input from a user, control the projection component to project a first graphic card onto the screen, and obtain a first image taken by the camera device for the first graphic card; cut the first graphic card in the first image to obtain a first graphic card image; perform binarization processing on the first graphic card image, and obtain a white connected region in the first graphic card image based on a binarization result; position a to-be-projected region based on the white connected region; and control the projection component to project a to-be-projected content to the to-be-projected region.

Embodiments of the present disclosure further provide a projection method for the projection apparatus, where the projection apparatus includes a projection component, a camera device and at least one processor, the projection method includes: in response to a projection command input from a user, controlling the projection component to project a first graphic card onto a screen, and obtaining a first image taken by the camera device for the first graphic card; cutting the first graphic card in the first image to obtain a first graphic card image; performing binarization processing on the first graphic card image, and obtaining a white connected region in the first graphic card image based on a binarization result; positioning a to-be-projected region based on the white connected region; and controlling the projection component to project a to-be-projected content to the to-be-projected region.

Embodiments of the present disclosure further provide a projection apparatus, including: a projection component, configured to project a projection content onto a screen; a camera device, configured to take an image of the screen; and at least one processor, in connection with the camera device and the projection component respectively, where the at least one processor is configured to execute instructions to cause the display apparatus to: obtain a first image, where the first image is an image of a region where the screen is located; process the first image to obtain a second image; where a pixel value of each pixel in the second image is a first pixel value or a second pixel value; based on that an area of a first connected region including the first pixel value in the second image is less than a first threshold area, adjust the first pixel value in the first connected region to the second pixel value to obtain a third image; determine a first rectangular region in the third image based on the second pixel value in the third image; where the first rectangular region is a largest rectangular region including the second pixel value in the third image; determine a to-be-projected region in the first rectangular region according to a preset length-to-width ratio; and control the projection component to project a to-be-projected content to the to-be-projected region.

Embodiments of the present disclosure further provide a projection method for the projection apparatus, where the projection apparatus includes a projection component, a camera device, and at least one processor, the projection method includes: obtaining a first image, where the first image is an image of a region where a screen is located; processing the first image to obtain a second image; where a pixel value of each pixel in the second image is a first pixel value or a second pixel value; based on that an area of a first connected region including the first pixel value in the second image is less than a first threshold area, adjusting the first pixel value in the first connected region to the second pixel value to obtain a third image; determining a first rectangular region in the third image based on the second pixel value in the third image; where the first rectangular region is a largest rectangular region including the second pixel value in the third image; determining a to-be-projected region in the first rectangular region according to a preset length-to-width ratio; and controlling the projection component to project a to-be-projected content to the to-be-projected region.

### BRIEF DESCRIPTION OF FIGURES

FIG. 1 is a schematic diagram of a projection system according to embodiments of the present disclosure;

FIG. 2 is a schematic structural diagram of a projection apparatus according to embodiments of the present disclosure;

FIG. 3 is a schematic diagram of a circuit architecture of a projection apparatus according to embodiments of the present disclosure;

FIG. 4 is a schematic diagram of a light path of a projection apparatus according to embodiments of the present disclosure;

FIG. 5 is a first schematic diagram of a projection apparatus according to embodiments of the present disclosure;

FIG. 6 is a schematic diagram of a system framework for implementing display control by a projection apparatus according to embodiments of the present disclosure;

FIG. 7 is a first schematic diagram of a screen according to embodiments of the present disclosure;

FIG. 8 is a second schematic diagram of a projection apparatus according to embodiments of the present disclosure;

FIG. 9 is a second schematic diagram of a screen according to embodiments of the present disclosure;

FIG. 10 is an interaction flowchart of a projection apparatus according to embodiments of the present disclosure;

FIG. 11 is a first schematic diagram of a connected region of a first graphic card image according to embodiments of the present disclosure;

FIG. 12 is a second schematic diagram of a connected region of a first graphic card image according to embodiments of the present disclosure;

FIG. 13 is a third schematic diagram of a connected region of a first graphic card image according to embodiments of the present disclosure;

FIG. 14 is a fourth schematic diagram of a connected region of a first graphic card image according to embodiments of the present disclosure;

FIG. 15 is a schematic diagram of a maximum rectangle according to embodiments of the present disclosure;

FIG. 16 is a first schematic diagram of a second graphic card according to embodiments of the present disclosure;

FIG. 17 is a second schematic diagram of a second graphic card according to embodiments of the present disclosure;

FIG. 18 is a first flowchart of a projection method according to embodiments of the present disclosure;

FIG. 19 is a second flowchart of a projection method according to embodiments of the present disclosure;

FIG. 20 is a third flowchart of a projection method according to embodiments of the present disclosure;

FIG. 21 is a fourth flowchart of a projection method according to embodiments of the present disclosure;

FIG. 22 is a fifth flowchart of a projection method according to embodiments of the present disclosure;

FIG. 23 is a sixth flowchart of a projection method according to embodiments of the present disclosure;

FIG. 24 is a seventh flowchart of a projection method according to embodiments of the present disclosure.

### DETAILED DESCRIPTION

In order to make purposes and embodiments of the present disclosure clearer, embodiments of the present disclosure will be described clearly and completely below in combination with the accompanying drawings in embodiments of the present disclosure. Obviously, the described embodiments are some but not all embodiments of the present disclosure.

Embodiments of the present disclosure can be applied to various types of projection apparatuses. Hereinafter, the projection apparatus and the projection method will be described by taking a projector as an example.

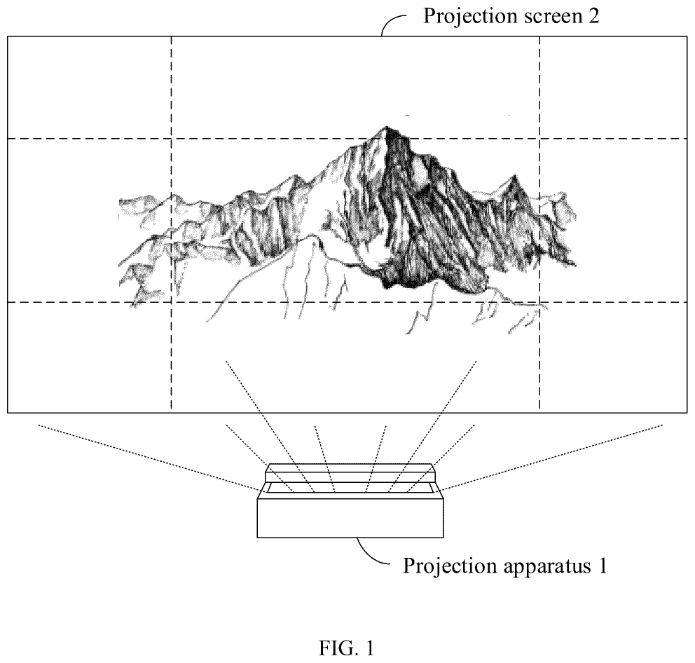

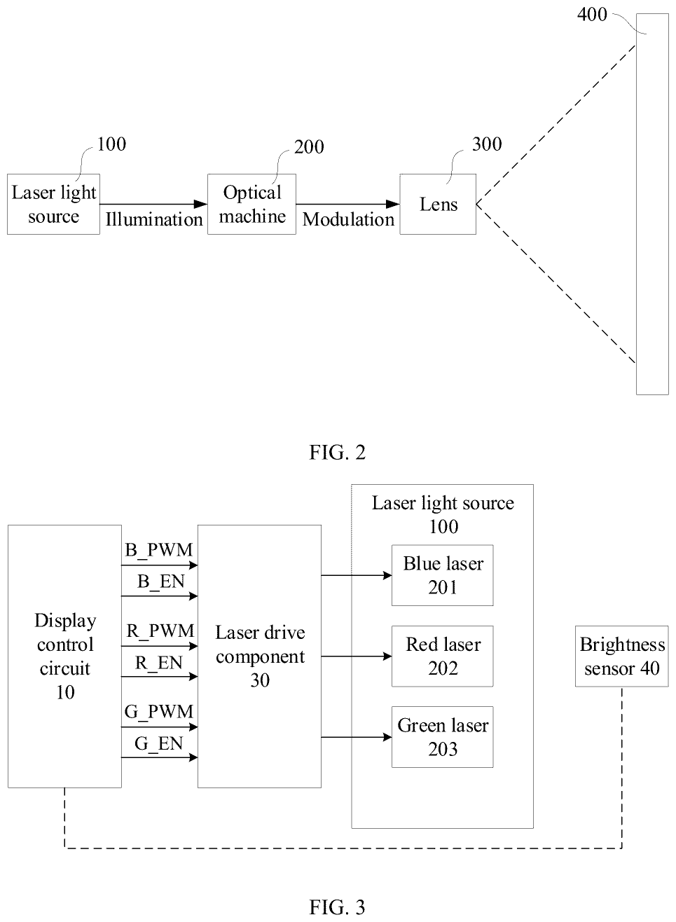

FIG. 1 is a schematic diagram of a projection system according to embodiments of the present disclosure, and FIG. 2 is a schematic structural diagram of a projection apparatus according to embodiments of the present disclosure.

In some embodiments, referring to FIG. 1, a projection system can include a projection apparatus 1 and a projection screen 2. The projection apparatus 1 is placed at a first position, and the projection screen 2 is fixed at a second position, so that an image projected from the projection apparatus 1 matches the projection screen 2. Referring to FIG. 2, the projection apparatus 1 includes a laser light source 100, an optical machine 200, and a lens 300. The laser light source 100 provides illumination for the optical machine 200, and the optical machine 200 modulates a light beam of the light source and outputs the light beam to the lens 300 for imaging. An image from the lens 300 is projected onto a projection medium 400 to form a projection image. In some examples, the projection medium 400 can also be a projection screen 2.

In some embodiments, the laser light source 100 of the projection apparatus 1 includes a laser component and an optical lens component. A light beam emitted by the laser component can pass through the optical lens component to provide illumination for the optical machine. The optical lens component requires a higher level of environmental cleanliness and airtight sealing. A chamber in which the laser component is mounted can use dustproof level sealing with a lower sealing level to reduce sealing costs.

In some embodiments, the optical machine 200 of the projection apparatus 1 can be implemented to include a blue optical machine, a green optical machine, a red optical machine, and can further include a heat dissipation system, a circuit control system, etc. It should be noted that, in some embodiments, a light emitting component of the projector can also be implemented by an LED light source.

FIG. 3 is a schematic diagram of a circuit architecture of a projection apparatus according to embodiments of the present disclosure. In some embodiments, the projection apparatus 1 can include a display control circuit 10, a laser light source 100, at least one laser drive component 30, and at least one brightness sensor 40. The laser light source 100 can include at least one laser in one-to-one correspondence with the at least one laser drive component 30. At least one refers to one or more, and a plurality refers to two or more.

In some embodiments, the laser light source 100 includes three lasers in one-to-one correspondence with laser drive components 30. The three lasers can be a blue laser 201, a red laser 202 and a green laser 203, respectively. The blue laser 201 is configured to emit blue laser light, the red laser 202 is configured to emit red laser light, and the green laser 203 is configured to emit green laser light. In some embodiments, the laser drive component 30 can be implemented to include a plurality of sub-laser drive components respectively corresponding to lasers of different colors.

The display control circuit 10 is configured to output control signals (e.g., an enable signal and a current control signal) to the laser drive component 30, to drive the laser to emit light. For example, the display control circuit 10 is in connection with a laser drive component 30, to output at least one enable signal in one-to-one correspondence with three primary colors of each frame of image in a plurality of frames of display images, transmit the at least one enable signal to corresponding laser drive components 30 respectively, and output at least one current control signal in one-to-one correspondence with the three primary colors of each frame of image, and transmit the at least one current control signal to corresponding laser drive components 30 respectively. For example, the display control circuit 10 can be a Micro Controller Unit (MCU), which is also called a single chip microcomputer. The current control signal can be a Pulse Width Modulation (PWM) signal.

As shown in FIG. 3, the display control circuit 10 can output a blue PWM signal B_PWM corresponding to the blue laser 201 based on a blue primary color component of a to-be-displayed image, output a red PWM signal R_PWM corresponding to the red laser 202 based on a red primary color component of the to-be-displayed image, and output a green PWM signal G_PWM corresponding to the green laser 203 based on a green primary color component of the to-be-displayed image. The display control circuit 10 can output an enable signal B_EN corresponding to the blue laser 201 based on a duration of illumination of the blue laser 201 during a drive period, output an enable signal R_EN corresponding to the red laser 202 based on a duration of illumination of the red laser 202 during the drive period, and output an enable signal G_EN corresponding to the green laser 203 based on a duration of illumination of the green laser 203 during the drive period.

A laser drive component 30 is in connection with a corresponding laser for providing a corresponding drive current to the laser to which the laser drive component 30 is connected in response to an enable signal and a current control signal received. Each laser is configured to emit light when driven by a drive current provided by the laser drive component 30.

For example, as shown in FIG. 3, the blue laser 201, the red laser 202, and the green laser 203 are respectively connected to a laser drive component 30. The laser drive component 30 can provide a corresponding drive current to the blue laser 201 in response to the blue PWM signal B_PWM and the enable signal B_EN sent from the display control circuit 10. The blue laser 201 is configured to emit light when driven by the drive current.

Based on the circuit architecture of FIG. 3, the projection apparatus 1 sets a brightness sensor 40 in a light emitting path of the laser light source 100, so that the brightness sensor 40 can detect a first brightness value of the laser light source and send the first brightness value to the display control circuit 10.

The display control circuit 10 can obtain a second brightness value corresponding to the drive current of each laser, and determine a catastrophic optical mirror damage (Catastrophic Optical Damage, abbreviated as COD) fault of the laser when determining that a difference between the second brightness value of the laser and the first brightness value of the laser is greater than a difference threshold. The display control circuit can adjust a current control signal of a laser drive component corresponding to the laser, until the difference is less than or equal to the difference threshold, to eliminate the COD fault of the blue laser. The projection apparatus can eliminate the COD fault of the laser in time and reduce the damage rate of the laser, to improve the image display effect of the projection apparatus 1.

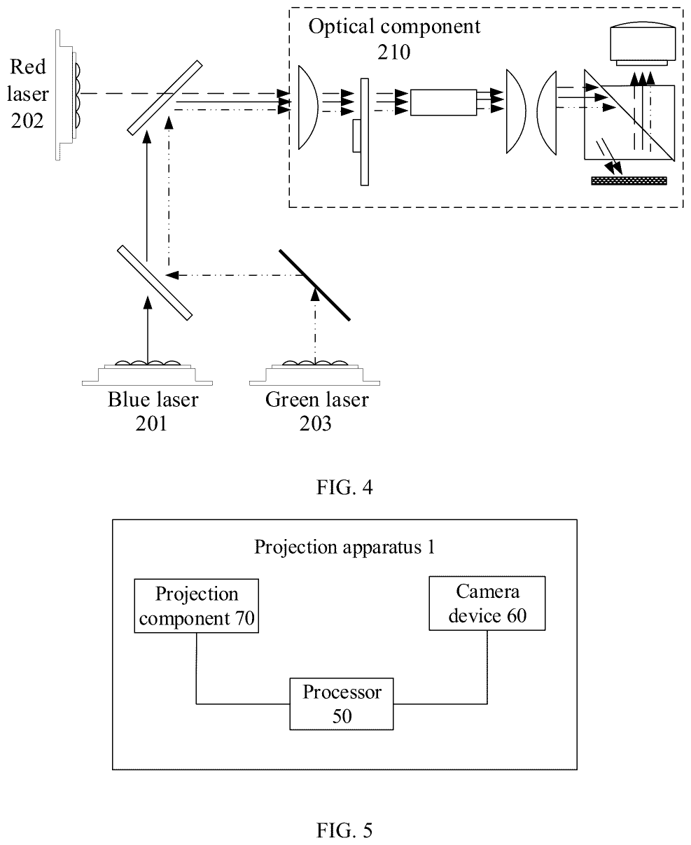

FIG. 4 is a schematic diagram of a light path of a projection apparatus according to embodiments of the present disclosure. In some embodiments, the laser light source 100 in the projection apparatus 1 can include a blue laser 201, a red laser 202, and a green laser 203 independently arranged. Therefore, the projection apparatus 1 can also be referred to as a three-color projection apparatus. The blue laser 201, the red laser 202, and the green laser 203 are small lasers (Multi_chip LD, abbreviated as MCL) with small volume, which is conducive to compact arrangement of optical paths.

As shown in FIG. 4, the optical machine 200 of the projection apparatus 1 includes an optical component 210. The optical component 210 can modulate a light beam provided by the laser light source 100 with an image signal of the to-be-displayed image, to obtain a projection beam.

FIG. 5 is a schematic diagram of a projection apparatus according to embodiments of the present disclosure. As shown in FIG. 5, in some embodiments, the projection apparatus 1 further includes at least one processor 50. The at least one processor 50 includes at least one of a Central Processing Unit (CPU), a video processor, an audio processor, a Graphics Processing Unit (GPU), a Random Access Memory (RAM), a Read-Only Memory (ROM), a first interface to an n^{th} interface for input/output, or a communication bus (Bus), etc.

In some embodiments, referring to FIG. 5, the projection apparatus 1 can further include a camera device 60 in connection with the at least one processor 50, for cooperating with the projection apparatus 1 for the purpose of regulating the projection process. For example, the camera device 60 provided in the projection apparatus 1 can be a general camera, a 3D camera, a binocular camera, or a depth camera. When the camera device 60 is a binocular camera, the camera device 60 includes a left camera and a right camera. The binocular camera can obtain the screen corresponding to the projection apparatus 1, that is, an image and a playing content presented by a projection plane. The image or the playing content is projected by the optical machine 200 provided in the projection apparatus 1.

In some embodiments, referring to FIG. 5, the projection apparatus 1 can further include a projection component 70. In some embodiments, the projection component 70 can include at least one of the laser light source 100, the optical machine 200, or the lens 300 in FIG. 2. For example, the projection component 70 can include a laser light source 100, an optical machine 200, and a lens 300. Alternatively, the projection component 70 can function as at least one of the laser light source 100, the optical machine 200, or the lens 300.

It should be noted that embodiments of the present disclosure can be applied to various types of projection apparatuses 1. For example, the projection apparatus 1 can be a projector. The projector is a projection apparatus that projects an image or video onto a screen. The projector can be connected with a computer, a radio and television network, the Internet, a Video Compact Disc (VCD), a Digital Versatile Disc Recordable (DVD), a game machine, a DV, etc. through different interfaces to play corresponding video signals. The projector is widely used in homes, offices, schools and entertainment venues. The projection apparatus 1 can also be other types of projection apparatuses, which is not limited in the present disclosure.

When the projection apparatus moves, a projection angle of the projection apparatus and a distance from the projection apparatus to a projection plane can change, resulting in deformation of a projection image. The projected image can be displayed as a trapezoidal image, or other misshapen image. The at least one processor of the projection apparatus may, based on an image taken by the camera, realize automatic trapezoidal correction through coupling of an included angle between the optical machine and the projection plane and correct display of the projection image.

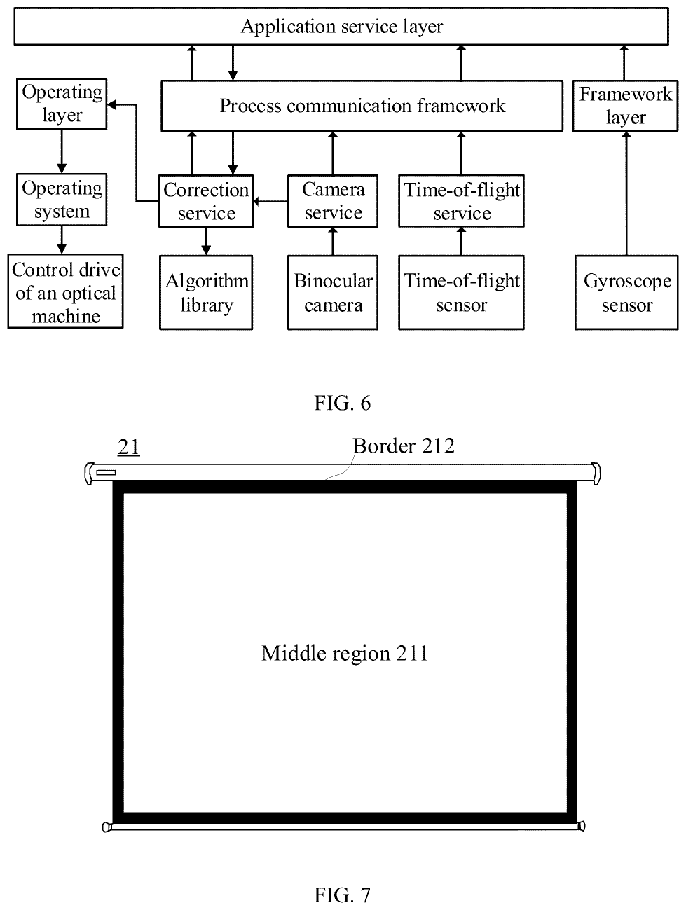

FIG. 6 is a schematic diagram of a system framework for implementing display control by a projection apparatus according to embodiments of the present disclosure. As shown in FIG. 6, in some embodiments, the projection apparatus has characteristics of telephoto and micro projection. The at least one processor of the projection apparatus can control display of the projection image through a preset algorithm, to realize functions of automatic trapezoidal correction, automatic screen entry, automatic obstacle avoidance, automatic focusing, and preventing eyes from being projected for a display image.

In some embodiments, the projection apparatus is configured with a gyroscope sensor. During movement of the projection apparatus, the gyroscope sensor can sense position movement and actively collect movement data, and then send collected data to an application service layer through a system framework layer, to support application data required in a process of user interface interaction and application interaction. The collected data can also be used for data call of the at least one processor in an algorithm service implementation.

In some embodiments, the projection apparatus is provided with a time-of-flight sensor. After the time-of-flight sensor collects corresponding data, collected data is sent to a time-of-flight service corresponding to a service layer. After the time-of-flight service obtains the data, the collected data is sent to an application service layer through a process communication framework. The data will be used for interactive use of data call, user interface, program application and the like of the at least one processor.

In some embodiments, the projection apparatus is configured with a camera for capturing images. The camera can be a binocular camera, a depth camera, a 3D camera, etc. Data collected by the camera is sent to a camera service, and then the camera service sends collected image data to a process communication framework and/or a projection apparatus correction service. The projection apparatus correction service can receive camera collected data sent from the camera service. The at least one processor can call a corresponding control algorithm in an algorithm library for different functions to be realized.

In some embodiments, data is interacted with an application service through a process communication framework, and then a calculation result is returned to a correction service through the process communication framework. The correction service sends the obtained calculation result to a projection apparatus operating system to generate a control signaling, and the control signaling is sent to a control drive of the optical machine to control a working condition of the optical machine and realize automatic correction of the display image.

In some embodiments, a user can use the projection apparatus in a variety of different scenarios. Different projection planes can be used as the projection medium 400 in different use scenarios. For example, some users need to project onto a Fresnel hard screen, that is, the projection medium 400 is a Fresnel hard screen; some users need to project onto a white wall, that is, the projection medium 400 is a white wall; some users need to project to a ceiling, that is, the projection medium 400 is the ceiling. For convenience of description, in embodiment of the present disclosure, the projection medium 400, the projection plane, the background wall, and the like all refer to a medium for presenting a projection image, and unless otherwise specified, the projection medium 400, the projection plane, and the background wall have the same meaning and function.

When the user needs to project on the wall or ceiling, the user can adjust the projection angle and position of the projection apparatus by himself, to enable the projection apparatus to project images to different regions until the user finds the best viewing region.

When the user desires to project a projection onto a specific region, such as a screen, the content projected by the projection apparatus can overlap with a blank region in the screen, so that the user can get the best viewing experience. Screen is a tool used to display images and video files in movies, offices, home theaters, large conferences and other occasions, and can be set to different specifications and sizes according to actual requirements. In order to make the display effect more in line with the user's viewing habits, the length-to-width ratio of the corresponding screen of the projector is generally set to 16:9 or 4:3, to accommodate the size of the image projected by the projection apparatus.

FIG. 7 is a schematic diagram of a screen according to embodiments of the present disclosure. As shown in FIG. 7, the screen 21 can include a middle region 211 and a border 212. The border 212 can be a dark border band, such as a black border, for highlighting a boundary of the screen. The middle region 211 of the screen can be a white screen for displaying an image projected by the projection apparatus.

In order to achieve the best projection effect, installation positions of the screen and the projection apparatus can be operated by professional technicians. By arranging the screen and the projection apparatus at placement positions where the best projection effect is achieved during operation, the image projected by the projection apparatus can be completely in the screen, to improve the experience of the user. In a use process, the user can also set positions of the screen and the projection apparatus, which is not limited by embodiments of the present disclosure.

Considering that the process of adjusting the projection apparatus by the user is more complicated, the projection apparatus can have an automatic screen entering function. The automatic screen entering function indicates that the projection apparatus can automatically determine a projection region in the screen and project the image to the projection region. Therefore, the user is prevented from manually adjusting the angle and the position of the projection apparatus, and the use experience of the user is improved. The projection apparatus can be provided with an automatic screen entering mode, and the user can send an automatic screen entering command to the projection apparatus, to enable the projection apparatus to enter the automatic screen entering mode to enable the automatic screen entering function of the projection apparatus.

In some embodiments, the user can send an automatic screen entering command to the projection apparatus by operating a designated key of a remote control. In a process of practical application, a corresponding relationship between the automatic screen entering command and the key of the remote control is pre-bound. For example, a key for the automatic screen entering mode is arranged on the remote control. When a user touches the key, the remote control sends an automatic screen entering command to the projection apparatus. In this case, the projection apparatus can enter the automatic screen entering mode. When the user touches the key again, the projection apparatus can exit the automatic screen entering mode.

In some embodiments, the projection apparatus is provided with a voice control function. The projection apparatus includes a sound collector, which can be a microphone. A user can use a sound collector of the projection apparatus to send an automatic screen entering command to the projection apparatus in a voice input mode, to control the projection apparatus to enter the automatic screen entering mode.

In some embodiments, a specific button can be provided on the projection apparatus, for controlling whether the projection apparatus enters an automatic screen entering mode or not. When the user presses the button, the projection apparatus can enter the automatic screen entering mode.

In some embodiments, a user can control the projection apparatus using a smart device, such as a mobile phone. The user can use the mobile phone to send automatic screen entering command to projection apparatus. In the process of practical application, a control can be set in the mobile phone. The control can be used to select whether to perform a process of the automatic screen entering mode, to send the automatic screen entering command to the projection apparatus.

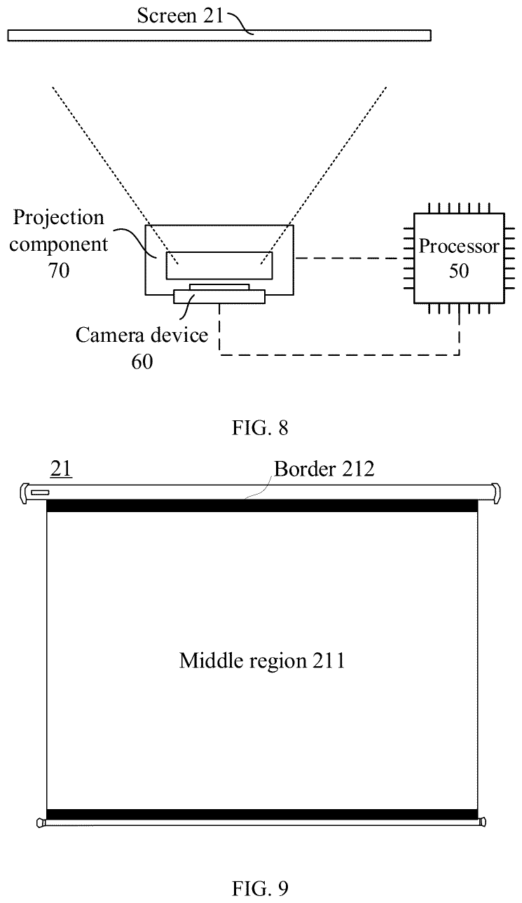

In order to enable the projection apparatus to realize the automatic screen entering function, as shown in FIG. 8, the projection apparatus includes at least one processor 50, a camera device 60, and a projection component 70. The projection component 70 is configured to project a projection content onto the screen 21. The projection content includes a user interface and a to-be-played media resource image. For example, when the user uses the remote control matched with the projection apparatus to set the projection apparatus, the projection component 70 can project a setting interface onto the screen 21. When the user uses the projection apparatus to watch multimedia resources such as movies and TV series, the projection component 70 can project a media image onto the screen 21.

The camera device 60 is configured to take an image, which can be an image of the screen 21. The camera device 60 can take an image of an environment in which the projection apparatus is located, to obtain a scenario image. The camera device 60 can collect images of different objects according to different photographing purposes. For example, when the projection apparatus adjusts the projection angle, the camera device 60 can photograph the screen 21, to obtain an image including a content of a to-be-projected image. When the projection apparatus automatically avoids an obstacle, the camera device 60 can photograph a target in front of the projection component 70, to obtain a sample image of an object including the obstacle.

In some embodiments, after the projection apparatus enters the automatic screen entering mode, placement of the screen 21 can be obtained, to determine a projection region in the screen. Considering that the screen 21 includes the border 212 and the middle region 211, the projection apparatus can identify the border of the screen. After the border of the screen is identified, the middle region 211 in the border, that is, a white screen region in the middle of the screen can be determined. The projection apparatus can determine the white screen region as the projection region, to project the image and other contents to the projection region.

When the projection apparatus automatically enters the screen, the at least one processor 50 can first control the projection component 70 to illuminate the screen 21, and a pure white graphic card can be projected onto the screen 21 so that the white graphic card covers the entire screen 21. The purpose is to show the border 212 of the screen 21 in the white graphic card to identify the border.

The at least one processor 50 can instruct the camera device 60 to photograph the screen 21, to obtain an image including the white graphic card and the entire screen. The obtained image can include a white graphic card region, and the white graphic card region can include the entire screen 21.

The at least one processor 50 can identify the image taken by the camera device 60, obtain a white graphic card region in the image, and obtain the screen in the white graphic card region to obtain the whole border of the screen, including borders corresponding to four edges. It should be noted that in order to enable the projection apparatus to accurately identify, the border of the screen has a certain thickness and includes an outer edge and an inner edge. The outer edge can be the edge of the whole screen. The inner edge forms the outline of the white region in the middle of the screen. Accordingly, the at least one processor 50 can identify the inner edge of the screen border, that is, identify four vertices of the inner edge, i.e., four inner corner points of the border. A rectangular region formed by the four inner corner points is a white screen region, and can be used as a projection region of the screen.

After determining the projection region, the at least one processor 50 can control the projection component 70 to project an image or the like onto the projection region, for the user to view.

However, in the actual application process, the complete border cannot be identified in the white graphic card region photographed by the camera device 60. That is, four borders cannot be identified, so that four inner corner points of the border cannot be determined, and the projection region cannot be obtained. For example, under the influence of factors such as the placement position or angle of the projection apparatus, after the projection component 70 projects the white graphic card onto the projection plane, the white graphic card cannot cover the whole screen, but only cover part of the screen, causing only part of the border to be in the white graphic card region. In this case, when identifying the white graphic card region, only part of the border can be obtained, so that not all the inner corner points of the frame can be identified. For example, only the left border of the screen is included in the white graphic card region, and the inner corner point of the border cannot be identified. In this case, the projection region cannot be determined because the complete four interior corner points cannot be obtained.

Or, influenced by the diversity of the screen, the screen border itself is not a complete rectangular structure. For example, the screen can be in the form of a single border, a double border, a triple border, or even no border. As shown in FIG. 9, the screen 21 only includes an upper border 212 and a lower border 212. Even when the white graphic card projected by the projection component 70 can cover the whole screen, when identifying the border of the screen, four borders cannot be identified, and four inner corner points cannot be determined. As a result, the projection region cannot be determined.

In a case that the projection region cannot be obtained, the projection apparatus cannot accurately project the image to the middle region 211 of the screen, resulting in a poor user experience.

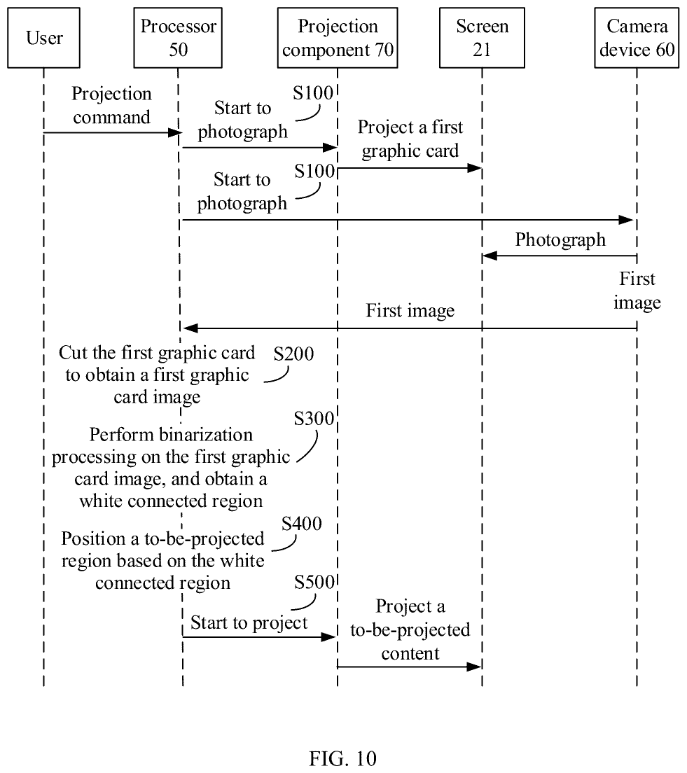

In order to accurately project an image to the middle region 211 of the screen, a projection apparatus is provided in embodiments of the present disclosure. The projection apparatus includes at least one processor 50, a camera device 60, and a projection component 70. The projection apparatus is configured to perform steps shown in FIG. 10.

S100: In response to a projection command input from a user, the at least one processor controls the projection component to project a first graphic card onto the screen, and obtains a first image taken by the camera device for the first graphic card on the screen.

The first graphic card does not include a feature point.

S200: The at least one processor cuts the first graphic card in the first image to obtain a first graphic card image.

S300: The at least one processor performs binarization processing on the first graphic card image, and obtains a white connected region in the first graphic card image based on a binarization result.

S400: The at least one processor positions a to-be-projected region based on the white connected region.

S500: The at least one processor controls the projection component to project a to-be-projected content to the to-be-projected region.

In some embodiments, after receiving the projection command input from the user, the projection apparatus can implement the automatic screen entering function, obtain the to-be-projected region, and project the to-be-projected content.

The at least one processor 50 can first control the projection apparatus 70 to project the first graphic card onto the screen 21. The first graphic card does not include a feature point and is used for illuminating the screen to determine the border of the screen. In order to prevent the content in the graphic card from affecting the identification of the border of the screen, the first graphic card can be a pure color graphic card, such as a white graphic card.

When projecting the first graphic card, the at least one processor can adjust a projection angle of the projection component 70 to a maximum angle, so that the projection component 70 is able to project an image with a maximum range. The first graphic card in the projection plane can cover the entire screen 21 as much as possible, to accurately identify the border of the screen.

After the projection component 70 projects the first graphic card, the screen 21 includes contents of the first graphic card. The at least one processor can control the camera device 60 to photograph the screen 21. The image taken by the camera device 60 for the first graphic card on the screen 21 is referred to as a first image. The first image can include contents of the first graphic card, and the first graphic card can include the screen 21.

In some embodiments, to avoid the influence of other regions, the at least one processor 50 can cut the first graphic card in the first image, to obtain an image corresponding to the first graphic card, which is called a first graphic card image. The first graphic card image is the first graphic card region, and the subsequent calculation amount and data processing can be reduced. The interference of the non-light emitting region can also be eliminated.

The at least one processor 50 can perform binarization processing on the first graphic card image to obtain a binarization result. It should be noted that the purpose of the binarization processing is to distinguish a black region from a white region in an image. Because the first graphic card image is a region corresponding to the first graphic card, and the first graphic card is a white graphic card, the first graphic card image includes a black border of the screen, while other regions are white regions.

Therefore, in the binarization result, the black part is the border of the screen, and the white part can include the middle region 211 of the screen, and can also include regions other than the screen illuminated by the first graphic card, such as a white wall.

The at least one processor 50 can divide the first graphic card image into a black region and a white region according to the binarization result. The black region is the border region. Considering that the region of the screen occupied by the border of the screen is relatively small, the entire first graphic card image can thus be considered as a white image including several borders, possibly including one border, including a plurality of borders or including no border.

The at least one processor 50 can obtain all connected regions, including a white connected region and a black connected region, in the first graphic card image based on the binarization result. A connected region indicates that the entire region is continuous and uninterrupted and includes only one color. The border 212 is a black connected region, and the middle region 211 of the screen is a white connected region. The entire white wall outside the screen is also a white connected region.

It should be noted that considering that the first graphic card projected by the projection component 70 cannot cover the entire screen 21, resulting in that a first graphic card image can include only a portion of the screen, there can be more than one black connected region and white connected region in the first graphic card image. When an image includes more than one border region, more than one black connected region can be included. When an image includes both a white screen and a white wall, a plurality of white connected regions can also be included.

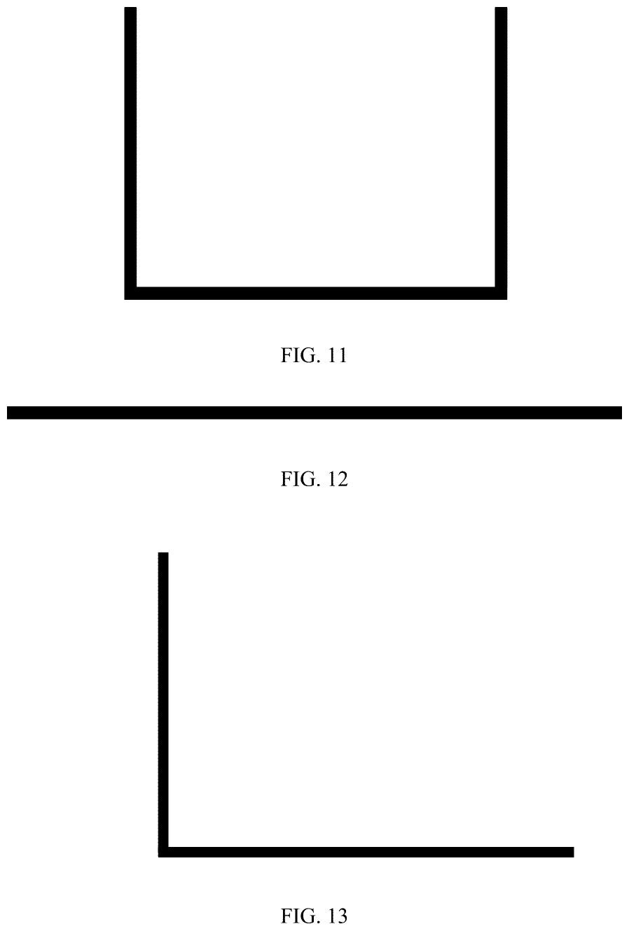

FIGS. 11 to 14 show a connected region of a first graphic card image. As shown in FIG. 11, the first graphic card image includes a black connected region and a white connected region. The border of the screen is U-shaped, that is, the screen only includes the left border, the right border and the lower border. The left border, the right border and the lower border of the screen form a black connected region together. The region other than black connected region forms a white connected region.

As shown in FIG. 12, the first graphic card image includes one black connected region and two white connected regions. A length of the border of the screen is the same as a length of the image. It can be a case that the screen only has a lower border, or it can be a case that only a part of the lower border of the screen is photographed. The lower border of the screen is a black connected region, an upper region of the lower border is a white connected region. A region below the lower border is also a white connected region.

As shown in FIG. 13, the first graphic card image includes one black connected region and two white connected regions. It can be a case that the screen only has the left border and the lower border, or it can be a case that only the lower left part of the screen is photographed. The left border and the lower border of the screen form a black connected region together. At the same time, the border of the screen divides the image into a rectangular white connected region and an L-shaped white connected region.

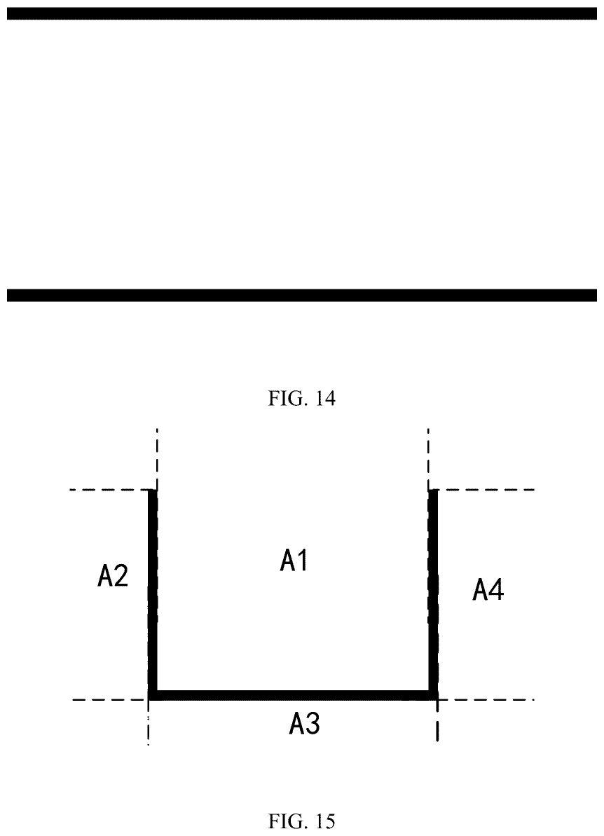

As shown in FIG. 14, the first graphic card image includes two black connected regions and three white connected regions. The image includes an upper border and a lower border of the screen, and the upper border and the lower border are respectively black connected regions. A lower region of the lower border is a white connected region, and an upper region of the upper border is a white connected region. A region between the upper border and the lower border is also a white connected region.

In some embodiments, the at least one processor 50 can obtain the white connected region in the first graphic card image, and position the to-be-projected region according to the white connected region.

The at least one processor 50 can detect a quantity of white connected regions. When the quantity of the white connected regions is different, the to-be-projected region can be positioned in different ways.

In some embodiments, when one white connected region is detected, the at least one processor 50 can first calculate an area of the first graphic card image, referred to as a first graphic card image area. At the same time, the at least one processor 50 can calculate an area of the white connected region, referred to as a white connected region area.

The at least one processor 50 can determine a size relationship between the area of the first graphic card image and the area of the white connected region.

When the area of the first graphic card image is equal to the area of the white connected region, it indicates that the first graphic card image is a complete white connected region, and does not include a black connected region, that is, does not include a border of the screen. In this case, the first graphic card projected by the projection component is completely in the white screen, possibly covering a part of the white screen, or just enough to completely cover the white screen.

In this case, the at least one processor 50 can directly determine the white connected region as a to-be-projected region. That is, the region projected by the first graphic card is used as the to-be-projected region.

In some embodiments, when one white connected region is detected, and the area of the first graphic card image is equal to the area of the white connected region, it indicates that the white connected region is the middle region of the screen. However, considering that an image ratio of the to-be-projected content does not match a size ratio of the white connected region, for example, the image ratio of the to-be-projected content can be 16:9 or 4:3, but the size ratio of the white connected region can be 16:13, when the white connected region is directly determined as the to-be-projected region, after the to-be-projected content is projected to the region, an image can exhibit undesirable effects such as stretching, affecting the user's viewing experience. Therefore, the white connected region can be processed to obtain the to-be-projected region.

The at least one processor 50 can cut the white connected region according to a first ratio and a second ratio respectively to obtain a first region and a second region. The first ratio can be 16:9 and the second ratio can be 4:3.

The at least one processor can calculate an area of the first region and an area of the second region, and calculate an area difference between the area of the first region S1 and the area of the second region S2. An area difference threshold can be preset in the projection apparatus, and the area difference threshold can be S1/5 or S2/5. The at least one processor 50 can detect a size relationship between the area difference and the area difference threshold.

When the area difference is less than or equal to a preset area difference threshold, one of the first region and the second region can be determined as a to-be-projected region, and can be determined according to an image ratio of the to-be-projected content.

When the area difference is greater than the preset area difference threshold, a region with the largest area in the first region and the second region can be determined as a to-be-projected region.

In some embodiments, when one white connected region is detected, and the area of the first graphic card image is larger than the area of the white connected region, it indicates that the first graphic card is not a complete white connected region, and includes several black connected regions, including the border of the screen. The at least one processor can determine the to-be-projected region according to the black connected region therein.

The at least one processor 50 can obtain an edge of a black connected region in the first graphic card image. The black connected region can include only one border, or can include a plurality of borders. Therefore, the at least one processor 50 can identify all edges of each black connected region.

In order to improve the viewing experience of the user, the to-be-projected region can be made as large as possible. The at least one processor 50 can obtain a maximum rectangle to be formed by the edge of the black connected region in the white connected region, and determine the maximum rectangle as a to-be-projected region.

In the first graphic card image, the edge of the black connected region is a black line segment, including a horizontal line and a vertical line. After all horizontal lines and vertical lines in the image are identified, each line segment can be taken as an edge, to obtain the largest rectangle to be formed by the edge in the white connected region. After obtaining maximum rectangles corresponding to all edges, the at least one processor can select a rectangle with the largest area from all the maximum rectangles, and determine the rectangle as a to-be-projected region.

FIG. 15 is a schematic diagram of a maximum rectangle according to embodiments of the present disclosure. As shown in FIG. 15, the screen includes a U-shaped border, and edges of the border are identified and the largest rectangles, including A1, A2, A3 and A4, are formed in the white connected region according to the edges. The at least one processor 50 can detect areas of the four rectangles and take the rectangle A1 having the largest area as the to-be-projected region.

In some embodiments, when two white connected regions are detected, the at least one processor can obtain a quantity of the corner points of each of the two white connected regions respectively.

When the quantity of corner points of each of the two white connected regions is a preset value, it indicates that the two white connected regions are regions of a preset shape. For example, the preset value can be 4. When the quantity of the corner points of each of the two white connected regions is 4, as shown in FIG. 12, it indicates that the two white connected regions are rectangular and can display an image.

The at least one processor 50 can obtain areas of the two white connected regions, and determine the white connected region with the largest area as a target white connected region. The at least one processor 50 can obtain the to-be-projected region based on the target white connected region.

In some embodiments, after the target white connected region is obtained, the at least one processor 50 can obtain a target ratio of the target white connected region. It should be noted that, in order to improve the viewing experience of the user, a size ratio of the to-be-projected region can be made as close as possible to the image ratio. An error threshold can be preset in the projection apparatus to detect an error in the target ratio and the image ratio. The error threshold can be 5%.

The at least one processor 50 can first calculate a first error between the target ratio and the first ratio and a second error between the target ratio and the second ratio. Taking the first ratio as an example, the error is calculated by obtaining a difference between the target ratio and the first ratio, and calculating a ratio of the difference to the first ratio, and the ratio is an error between the target ratio and the first ratio. For example, when the target ratio is 16:10 and the first ratio is 16:9, the difference is 1/16, and the ratio of the difference to the first ratio is 1/9, that is, the first error is 1/9.

When at least one of the first error and the second error is less than or equal to a preset error threshold, the first error can be less than or equal to the error threshold, the second error can be less than or equal to the error threshold, or both the first error and the second error can be less than or equal to the error threshold. The at least one processor 50 can then determine the target white connected region as the to-be-projected region.

When both the first error and the second error are greater than the preset error threshold, the at least one processor 50 can cut the target white connected region according to the first ratio and the second ratio respectively, to obtain third region and a fourth region. The at least one processor 50 can determine a region with the largest area in the third region and the fourth region as a to-be-projected region.

When the quantity of the corner points of only one of the two white connected regions is the preset value, it indicates that only one white connected region is the region of the preset shape. As shown in FIG. 13, one of the white connected regions is rectangular, and the other one of the white connected regions is L-shaped. The at least one processor 50 can determine the rectangular white connected region as the to-be-projected region.

In some embodiments, when three white connected regions are detected, the at least one processor 50 can obtain a positional relationship between the three white connected regions. The three white connected regions can be arranged from left to right or from up to down. As shown in FIG. 14, the three white connected regions are arranged from up to down. Based on the positional relationship, the at least one processor 50 can determine the white connected region in a middle position as the to-be-projected region.

When more than three white connected regions are detected, the white connected region in a middle position can also be determined as the to-be-projected region.

In some embodiments, considering that there are at most four borders of the screen, the borders can divide the first graphic card image into three white connected regions at most.

When the quantity of detected white connected regions is greater than four, it indicates that there can be some obstacles or there are some contents on the white wall to form a black connected region, causing interference. The at least one processor 50 can select the white connected region with the largest area as the to-be-projected region.

The at least one processor 50 can also control the projection component 70 to adjust the projection angle and other parameters, re-project the first graphic card, and repeat the above steps, to re-obtain the to-be-projected region.

In some embodiments, after the to-be-projected region is obtained, the at least one processor can control the projection component 70 to project the to-be-projected content to the to-be-projected region.

In order to project the image to the to-be-projected region, the at least one processor 50 can first determine a projection relationship between the screen 21 and the projection apparatus. In embodiments of the present disclosure, the projection relationship refers to a projection relationship in which the projection apparatus projects the image onto the screen 21, i.e., a projection relationship between the content projected by the projection component 70 of the projection apparatus and the screen 21. After determining the projection relationship between the screen 21 and the projection apparatus, the projection apparatus can determine position information of the to-be-projected region in the screen 21, to project the to-be-projected content to the to-be-projected region, for the user to view.

The projection apparatus can project a second graphic card onto the screen 21, and determine position information of the screen 21 according to the second graphic card. According to the position information of the screen 21, a projection relationship between the screen 21 and the projection apparatus can be further determined.

It should be noted that, in embodiments of the present disclosure, a transformation matrix of the screen under a world coordinate system and a projection component coordinate system can be constructed based on a binocular camera. The transformation matrix is a homography relationship between a projection image in the screen and a playing graphic card played by the projection component. The homography relationship is also referred to as a projection relationship. Any projection transformation between the projection image and the playing graphic card can be realized by using the homography relationship.

In some embodiments, to obtain a mapping relationship, the at least one processor 50 can first control the projection apparatus 70 to project the second graphic card onto the screen 21. After the second graphic card is projected, the at least one processor 50 can further control the camera device 60 to photograph the second graphic card to obtain a second image.

The second graphic card can include several feature points. Therefore, the second image taken by the camera device 60 also includes all feature points in the second graphic card. Position information of the screen 21 can be determined by the feature points. It should be noted that for a plane, after positions of three points in the plane are determined, position information of the plane can be determined. Therefore, in order to determine the position information of the screen 21, it is necessary to determine positions of at least three points in the screen 21, that is, the second graphic card needs to include at least three feature points. The position information of the screen 21 can be determined according to the at least three feature points.

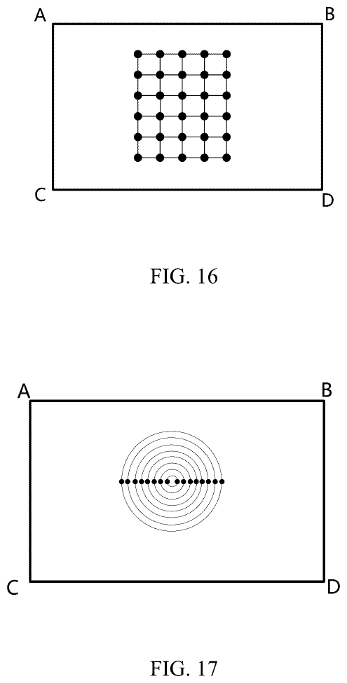

In some embodiments, the second graphic card can include patterns and color characteristics preset by the user. The second graphic card can be a checkerboard graphic card, and the checkerboard graphic card is set as a checkerboard with black and white. As shown in FIG. 16, feature points included in the checkerboard card are corner points of a rectangle. The pattern in the second graphic card can also be set as a ring graphic card, including a ring pattern. As shown in FIG. 17, feature points included in the ring graphic card are corresponding solid points on each ring. In some embodiments, the second graphic card can also be configured as a combination of two types of patterns described above, or as other patterns with identifiable feature points.

In some embodiments, after the projection component 70 projects the second graphic card onto the screen 21, the at least one processor 50 can control the camera device 60 to photograph the second graphic card to obtain a second image, to obtain positions of feature points.

The camera device 60 can be a binocular camera, and one camera is disposed on each side of the projection component 70. The second graphic card is photographed by the binocular camera, one image is taken by the left camera, and the other image is taken by the right camera.

The at least one processor 50 can perform image recognition processing on the two images to obtain a first coordinate of a feature point in any of the images. In embodiments of the present disclosure, the first coordinate refers to coordinate information of the feature point under an image coordinate system corresponding to the second image.

The image coordinate system refers to a coordinate system in which a center of an image is taken as a coordinate origin and X and Y axes are parallel to both sides of the image. The image coordinate system in embodiments of the present disclosure can be set as follows: for a projection region preset by a user, a center point of the projection region can be set as the origin, the horizontal direction can be set as the X axis, and the vertical direction can be set as the Y axis. An image coordinate system can be set in advance according to a preset projection region.

Coordinate information of the feature point in the second image can be determined according to the image coordinate system.

For the same feature point, a position of the feature point in the image taken by the left camera and a position of the feature point in the image taken by the right camera can be different. Coordinates of the feature point under a camera device coordinate system of either of the left camera and the right camera can be determined by two positions of the same feature point in the two images. In embodiments of the present disclosure, a second coordinate is used to represent coordinate information of the feature point under the camera device coordinate system.

In embodiments of the present disclosure, the camera device coordinate system is a cartesian coordinate system taking a light spot of the camera device as a center, an optical axis as a Z axis, and a plane parallel to the screen as an XOY plane.

For a binocular camera, a second coordinate of a feature point in a camera device coordinate system corresponding to any one of the cameras is determined. In embodiments of the present disclosure, the left camera is taken as an example.

According to position information of the same feature point in the two images taken by the left camera and the right camera, second coordinate information of the feature point under the camera device coordinate system of the left camera is determined and set as:
P(x, y, z).

In some embodiments, after the second coordinate of the feature point under the camera device coordinate system of the left camera is obtained, the at least one processor 50 can convert the second coordinate into a third coordinate. The third coordinate refers to coordinate information of the feature point under a projection component coordinate system.

In embodiments of the present disclosure, the projection component coordinate system is a cartesian coordinate system taking a light spot of the projection component as a center, an optical axis as a Z axis, and a plane parallel to the screen as an XOY plane. It should be noted that the projection component coordinate system and the camera device coordinate system can be converted to each other. Therefore, the coordinate of the feature point under the camera device coordinate system can be converted into the coordinate under the projection component coordinate system. The feature point can be converted between the two coordinate systems according to external parameters between the projection component and the camera device. The external parameters between the projection component and the camera device are apparatus parameters that have been marked on an apparatus shell or the manual when the projection apparatus is manufactured and delivered, are generally set based on the function, assembly, manufacture and parts of the projection apparatus, are applicable to all projection apparatuses of the same model, and may include a rotation matrix and a translation matrix between the projection component and the camera device.

According to the external parameters between the projection component and the camera device, a conversion relationship between the projection component coordinate system and the camera device coordinate system can be determined, and the coordinate of the feature point under the projection component coordinate system is further obtained. The conversion formula is as follows:

$${P}^{′} ( {x}^{′} , {y}^{′} , {z}^{′} ) = RRR * P + TTT . \qquad ( 1 )$$

Where P′(x′, y′, z′) is the coordinate of the feature point under the projection component coordinate system. RRR is the rotation matrix between the projection component and the camera device, and TTT is the translation matrix between the projection component and the camera device.

In some embodiments, after the coordinate of the feature point under the projection component coordinate system is obtained, a projection plane equation of the screen 21 under the projection component coordinate system can be determined.

It should be noted that coordinate information of at least three points is required to determine the position information of a plane. Therefore, the at least one processor can obtain first positions of at least three feature points in at least a second image, and determine coordinate information under a camera device coordinate system according to the first positions of the feature points. The coordinate information under the camera device coordinate system can be further converted into the coordinate information under the projection component coordinate system.

After the coordinate information of at least three feature points under the projection component coordinate system is determined, the at least one processor 50 can fit the coordinates of these feature points to obtain the projection plane equation of the screen under the projection component coordinate system. The projection plane equation can be expressed as:

$$z = ax + by + c \qquad ( 2 )$$

or the following formula:

$$( \begin{matrix}{x}_{1}^{′} & {y}_{1}^{′} & 1 \\ {x}_{2}^{′} & {y}_{2}^{′} & 1 \\ {x}_{n}^{′} & {y}_{n}^{′} & 1\end{matrix} ) ( \begin{matrix}a \\ b \\ c\end{matrix} ) = ( \begin{matrix}{z}_{1} \\ {z}_{2} \\ {z}_{n}\end{matrix} ) . \qquad ( 3 )$$

In some embodiments, after determining the projection plane equation of the screen under the projection component coordinate system, the at least one processor can obtain a transformation matrix of the projection component coordinate system and a world coordinate system according to the projection plane equation. The transformation matrix is used for representing a projection relationship.

In embodiments of the present disclosure, the world coordinate system is a spatial coordinate system established by taking an image coordinate system as an XOY plane, namely taking a screen as an XOY plane, a center point of a projection region preset by a user as an origin, and a direction perpendicular to the screen as a Z axis.

When obtaining the transformation matrix of the projection component coordinate system and the world coordinate system, the at least one processor 50 can determine a representation of the screen under a world coordinate system and a representation of the screen under a projection component coordinate system respectively.

The at least one processor 50 can first determine a unit normal vector of the screen under the world coordinate system.

Since the screen itself is the XOY plane of the world coordinate system, the unit normal vector of the screen under the world coordinate system can be expressed as:

$$m = ( 0 , 0 , 1 ) * T . \qquad ( 4 )$$

The at least one processor 50 can also obtain the unit normal vector of the screen under the projection component coordinate system according to the projection plane equation of the screen under the projection component coordinate system, the unit normal vector of the screen under the projection component coordinate system can be expressed by the formula:

$$n = ( \frac{a}{\sqrt{{a}^{2} + {b}^{2}}} , \frac{b}{\sqrt{{a}^{2} + {b}^{2}}} , \frac{- 1}{\sqrt{{a}^{2} + {b}^{2}}} ) * T . \qquad ( 5 )$$

According to unit normal vectors of the screen under the two coordinate systems, the transformation matrix between the projection component coordinate system and the world coordinate system can be obtained, and the correlation is expressed as the following formula:

$$m = R 1 * n . \qquad ( 6 )$$

Where: R1 represents the transformation matrix between the projection component coordinate system and the world coordinate system. The transformation matrix can represent the mapping relationship between the content projected by the projection component and the screen.

After the mapping relationship is determined, the at least one processor 50 can implement conversion of a coordinate of a certain point between the world coordinate system and the projection component coordinate system.

For a certain target region that has been determined in the screen, a coordinate representation of the target region under the world coordinate system can be determined according to position information of the target region in the screen. The at least one processor 50 can convert a coordinate representation under the world coordinate system to a coordinate representation under the projection component coordinate system according to a transformation matrix, to determine position information of the target region for the projection apparatus, and to further project the image directly to the target region.

Therefore, the at least one processor 50 can obtain the position information of the to-be-projected region, i.e., the coordinate representation of the to-be-projected region under the projection component coordinate system, based on the mapping relationship. According to the position information, the at least one processor 50 can control the projection component 70 to project the to-be-projected content to the to-be-projected region, for the user to view.

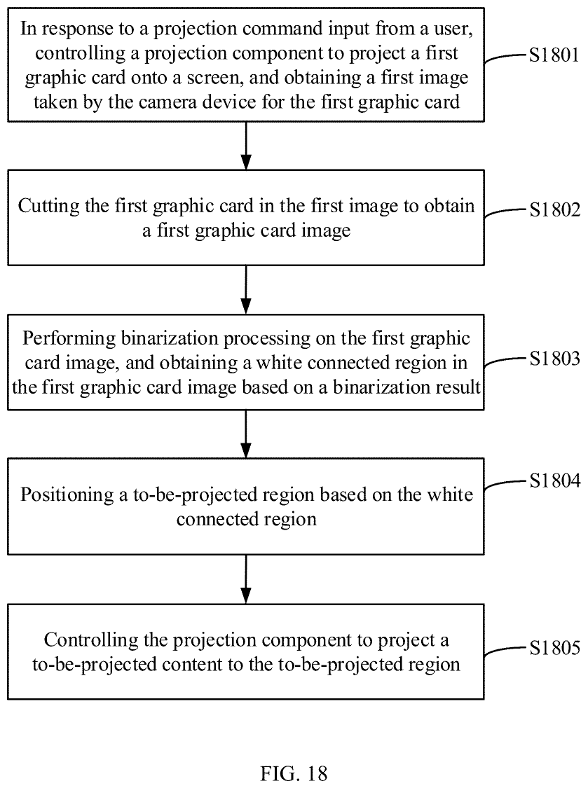

Based on the same inventive concept, embodiments of the present disclosure further provide a projection method applied to a projection apparatus, as shown in FIG. 18. The method includes following steps.

S1801: In response to a projection command input from a user, controlling a projection component to project a first graphic card onto a screen, and obtaining a first image taken by the camera device for the first graphic card.

S1802: Cutting the first graphic card in the first image to obtain a first graphic card image.

S1803: Performing binarization processing on the first graphic card image, and obtaining a white connected region in the first graphic card image based on a binarization result.

S1804: Positioning a to-be-projected region based on the white connected region.

S1805: Controlling the projection component to project a to-be-projected content to the to-be-projected region.

In some embodiments, the positioning the to-be-projected region based on the white connected region includes: calculating an area of the first graphic card image and an area of the white connected region based on detecting one white connected region; based on that the area of the first graphic card image is equal to the area of the white connected region, determining the white connected region as the to-be-projected region.

In some embodiments, after calculating the area of the first graphic card image and the area of the white connected region, the method includes: calculating the area of the first graphic card image and the area of the white connected region based on the detecting one white connected region; based on that the area of the first graphic card image is equal to the area of the white connected region, cutting the white connected region according to a first ratio and a second ratio respectively to obtain a first region and a second region; calculating an area of the first region and an area of the second region, and calculating an area difference between the area of the first region and the area of the second region; based on that the area difference is less than or equal to a preset area difference threshold, determining the first region or the second region as the to-be-projected region; based on that the area difference is greater than the preset area difference threshold, determining a region with the largest area in the first region and the second region as the to-be-projected region.

In some embodiments, after calculating the area of the first graphic card image and the area of the white connected region, the method includes: based on that the area of the first graphic card image is greater than the area of the white connected region, obtaining an edge of a black connected region in the first graphic card image; obtaining a maximum rectangle to be formed by the edge in the white connected region, and determining the maximum rectangle as the to-be-projected region.

In some embodiments, the positioning the to-be-projected region based on the white connected region includes: based on detecting two white connected regions, obtaining a quantity of corner points of each of the two white connected regions; based on that the quantity of the corner points of each of the two white connected regions is a preset value, obtaining areas of the two white connected regions, and determining the white connected region with the largest area as a target white connected region; obtaining the to-be-projected region based on the target white connected region; based on that the quantity of the corner points of only one of the two white connected regions is the preset value, determining the white connected region with the quantity of the corner points being the preset value as the to-be-projected region.

In some embodiments, the obtaining the to-be-projected region based on the target white connected region includes: obtaining a target ratio of the target white connected region; calculating a first error between the target ratio and a first ratio, and calculating a second error between the target ratio and a second ratio; based on that the first error and/or the second error are less than or equal to a preset error threshold, determining the target white connected region as the to-be-projected region; based on that the first error and the second error are both greater than the preset error threshold, cutting the target white connected region according to the first ratio and the second ratio respectively, to obtain a third region and a fourth region; determining a region with the largest area in the third region and the fourth region as the to-be-projected region.

In some embodiments, the positioning the to-be-projected region based on the white connected region includes: based on detecting three or more white connected regions, obtaining a positional relationship between the white connected regions; based on the positional relationship, determining the white connected region in a middle position as the to-be-projected region.

In some embodiments, before controlling the projection component to project the to-be-projected content to the to-be-projected region, the method includes: controlling the projection component to project a second graphic card onto the screen, and obtaining a second image taken by the camera device for the second graphic card, where the second graphic card includes a feature point; obtaining a mapping relationship between the content projected by the projection component and the screen based on the second image.

The controlling the projection component to project the to-be-projected content to the to-be-projected region includes: obtaining position information of the to-be-projected region based on the mapping relationship; controlling the projection component to project the to-be-projected content to the to-be-projected region based on the position information.

In some embodiments, the obtaining the mapping relationship between the content projected by the projection component and the screen based on the second image includes: obtaining a first coordinate of the feature point of the second graphic card under an image coordinate system corresponding to the second image; obtaining a second coordinate of the feature point under a camera device coordinate system based on the first coordinate; converting the second coordinate into a third coordinate of the feature point under a projection component coordinate system; obtaining a projection plane equation of the screen under the projection component coordinate system based on the third coordinate; obtaining a transformation matrix of the projection component coordinate system and a world coordinate system based on the projection plane equation, where the transformation matrix is used for representing the mapping relationship.

The screen shown in FIG. 7 can be referred to as a four-sided screen. Because an edge of the four-sided screen has a relatively obvious border 212, the projection apparatus can take advantage of this feature, to identify the four-side screen stably, efficiently and accurately in an environment, so that the screen can be quickly entered after the projection apparatus is moved.

However, other types of screens exist besides the four-sided screen, such as the two-sided screen shown in FIG. 9. Two edges of the two-sided screen have dark borders 212, and the other two edges do not have dark borders 212. In the two-sided screen shown in FIG. 9, the upper edge and the lower edge can respectively have black border 212 with a certain width, while the left edge and the right edge do not have a border 212. Therefore, four edges of the two-sided screen cannot form a closed quadrilateral (for example, a rectangle). In this way, when projecting, the projection apparatus cannot be able to accurately identify a position of the two-sided screen, or, the projection apparatus can identify the two-sided screen as an obstacle and thus cannot accurately project the to-be-projected content onto the screen 21.

In order to solve the above problems, the projection apparatus proposed in embodiments of the present disclosure, for screens of other sizes than a four-sided screen (such as a two-sided screen), can accurately project the projection content to the middle region of the screen 21. Universality of the projection apparatus to the screen is improved.

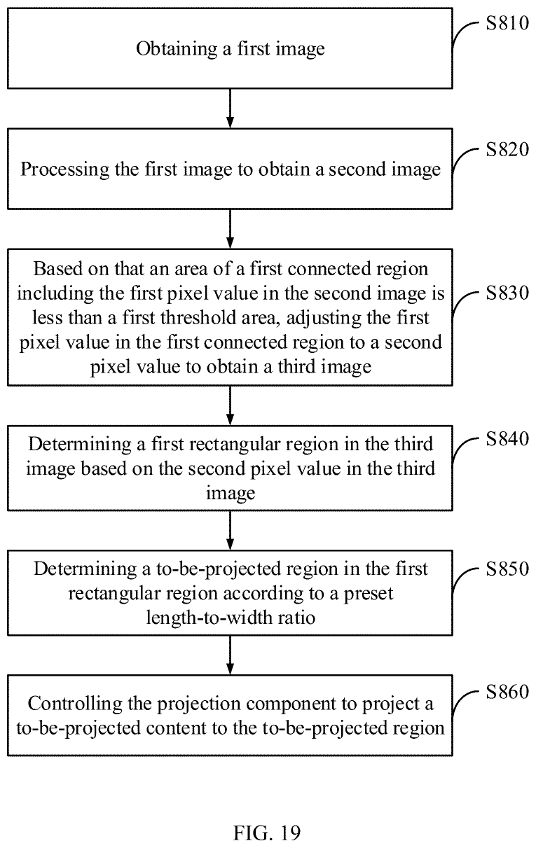

FIG. 19 is a flowchart of a projection method according to embodiments of the present disclosure. As shown in FIG. 19, the projection method for a projection apparatus includes following steps.

S810: Obtaining a first image, where the first image is an image of a region where the screen is located.

In some embodiments, the camera device 60 can obtain the first image by photographing the region where the screen 21 is located. For example, the first image can include various objects in an environment of the region where the screen 21 is located, such as walls, wall hangings, wallpapers, etc. In some embodiments, the first image taken by the camera device 60 can be a color image or cannot be a color image. In this embodiment, the first image taken by the image capturing device 60 is a color image.

The camera device 60 sends the first image taken to the at least one processor 50, and the at least one processor 50 receives the first image.

S820: Processing the first image to obtain a second image; where a pixel value of each pixel in the second image is a first pixel value or a second pixel value.

After receiving the first image sent from the camera device 60, the at least one processor 50 performs corresponding processing on the first image. In some embodiments, the at least one processor 50 can perform processing such as grayscale conversion, cutting, binarization, etc., on the first image received, to obtain a second image. The pixel value of each pixel in the second image obtained is the first pixel value or the second pixel value, that is, the second image only includes two kinds of pixel values, that is, the pixel values in the second image are pixel values of two different colors, to facilitate identification of the screen 21 by the projection apparatus.

For example, the first pixel value can be a pixel value of 0, the second pixel value can be a pixel value of 255. In this way, the second image includes black pixels with a pixel value of 0 and white pixels with a pixel value of 255, to further improve accuracy of the identification of the screen 21.

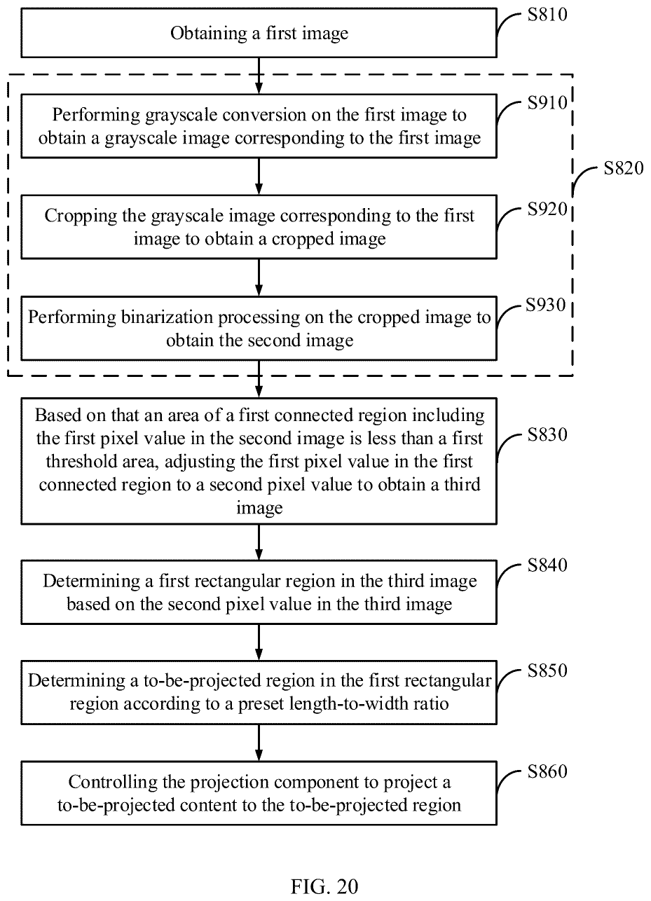

In some embodiments, as shown in FIG. 20, the step S820 in which the first image is processed to obtain the second image includes S910 to S930.

S910: Performing grayscale conversion on the first image to obtain a grayscale image corresponding to the first image.

Generally, the first image is a color image taken by the camera device 60. In order to more easily and accurately identify a region of the screen 21 in an environmental factor in the first image, the at least one processor 50 can perform identification conversion processing based on the first image obtained, to convert the first image with color into a grayscale image corresponding to the first image. For example, the at least one processor 50 may, based on a preset condition, adjust a gray value of each pixel in the first image according to a preset transformation relationship to obtain a grayscale image corresponding to the first image. The grayscale image corresponding to the first image has better image quality and better display effect than the first image.

S920: Cropping the grayscale image corresponding to the first image to obtain a cropped image. The cropped image includes the screen 21.

Generally, a size of the first image is relatively large. For example, the first image can be an image of an entire wall including the region of the screen 21. In order to position a position of the region of the screen 21 more quickly, the at least one processor 50 can crop a grayscale image corresponding to the first image, to obtain the cropped image. A size of the cropped image is less than a size of the grayscale image corresponding to the first image, and the cropped image is a part of the first image including the region of the screen 21.

In some embodiments, the at least one processor 50 can crop a grayscale image corresponding to the first image according to a preset parameter. The preset parameter can be, for example, a parameter set in advance inside the projection apparatus, or can be a default parameter in the projection apparatus. For example, the preset parameter can be set based on internal and external parameters of the optical machine 200. For example, when the preset parameter in the projection apparatus is 50 px×50 px, when the size of the grayscale image corresponding to the first image is 100 px×100 px, the at least one processor 50 can crop out an image with a size of 50 px×50 px including the region of the screen 21 in the grayscale image corresponding to the first image of 100 px×100 px as the cropped image.

In some embodiments, the at least one processor 50 can also crop the first image based on a maximum projection region of the projection apparatus. The maximum projection region of the projection apparatus is related to a device type of the projection apparatus. Different types of projection apparatuses can correspond to different areas of maximum projection regions. For example, the projection apparatus 1 can crop a region with the same size as the maximum projection region in a grayscale image corresponding to the first image as the cropped image.

It should be noted that the execution order of step S920 and step S930 is not limited in the present disclosure. For example, step S930 can be performed first to crop the first image, and then step S920 is performed to perform grayscale conversion on the cropped first image.

S930: Performing binarization processing on the cropped image to obtain the second image.

Performing binarization processing on the cropped image is to set a pixel value (also called grayscale value) of each pixel point in the cropped image to 0 or 255, that is, the cropped image presents a clear visual effect of only black and white. Pixels in the second image obtained after the binarization processing only have two kinds of pixel values, i.e., the pixel value of each pixel is a first pixel value (e.g., pixel value 0) or a second pixel value (e.g., pixel value 255), so that only two colors (e.g., black and white) are included in the second image. Therefore, by performing binarization processing on the cropped image, the accuracy of the identification of the region of the screen 21 by the projection apparatus can be further improved.

In some embodiments, a preset pixel threshold can be set in the at least one processor 50, and the preset pixel threshold is used as a standard, to compare and divide pixel values of pixels in the cropped image. When the pixel value of a certain pixel in the cropped image is less than preset pixel threshold value, the pixel value of the pixel is set to the first pixel value. When the pixel value of a certain pixel in the cropped image is greater than or equal to the preset pixel threshold, the pixel value of the pixel is set to the second pixel value.

The preset pixel threshold can be obtained by multiple tests. For example, the preset pixel threshold can be 100. That is to say, when the pixel value of a certain pixel in the cropped image is less than 100, the pixel value of the pixel is adjusted to the first pixel value (e.g., pixel value 0). When the pixel value of a certain pixel in the cropped image is greater than or equal to 100, the pixel value of the pixel is adjusted to the second pixel value (e.g., pixel value 255). For example, for a two-sided screen, after the binarization processing, the borders 212 at the upper edge and the lower edge can be displayed in black (pixel value of 0), the middle region 211 of the screen can be displayed in white (pixel value of 255). It should be noted that the left edge and the right edge of the two-sided screen can be white. Therefore, it is still impossible to determine the exact region of the screen 21, and it is necessary to continue to perform step S830 for further determination.

S830: Based on that an area of a first connected region including the first pixel value in the second image is less than a first threshold area, adjusting the first pixel value in the first connected region to a second pixel value to obtain a third image.

Pixels with the first pixel value in the second image can constitute a plurality of first connected regions. Pixels with the second pixel value can constitute a plurality of second connected regions. The second connected region includes the region of the screen 21.

The first connected region and the second connected region can each be a closed pattern. For example, the first connected region can include all black pixels, that is, the pixel value of each pixel in the first connected region is 0. The second connected region can include all white pixels, that is, the pixel value of each pixel in the second connected region is 255.

In some embodiments, a quantity of each of the first connected region and the second connected region can also be one, or, the quantity of each of the first connected region and the second connected region can be more than one. When the quantity of each of the first connected region and the quantity of the second connected region is more than one, a size (e.g., a size of an area) of each first connected region or each second connected region can be the same or different.

The first threshold area can be obtained by a lot of tests. For example, the first threshold area can be a quarter of an area of the largest first connected region among a plurality of first connected regions. The first threshold area can be used to indicate whether the first connected region affects the projection effect of the projection apparatus, or in other words, the first threshold area can be used to indicate whether the first connected region is likely to be part of the projection region of the projection apparatus.

In some embodiments, when the area of the first connected region including the first pixel value is less than first threshold area, it is considered that the first connected region is small, and the first connected region does not include obstacles that affect the projection of the projection apparatus. Therefore, in order to avoid color abrupt regions (or patches) in the screen 21, pixel values (e.g., the first pixel values) of these color abrupt patches can be processed. For example, the pixel value of the portion (e.g., pixel value 0) can be adjusted to be modified to a second pixel value (e.g., pixel value 255).

When the area of the first connected region is larger than first threshold area, the first connected region can be an obstacle region and cannot be ignored. The pixel value in the first connected region cannot be adjusted, i.e., the first pixel value can be maintained.

After the processing in step S830, a third image is obtained. The third image includes one or more second connected regions. The largest second connected region can include the middle region of the screen 21.

S840: Determining a first rectangular region in the third image based on the second pixel value in the third image; where the first rectangular region is the largest rectangular region including the second pixel value in the third image.

Second pixel values constitute a plurality of second connected regions. The largest second connected region among the plurality of second connected regions is determined first. A first rectangular region is then determined in this largest second connected region, that is, the first rectangular region can be the largest rectangular region including the second pixel values in the second connected region.

It should be noted that the first rectangular region can also be referred to as a first rectangle. The screen 21 is generally a rectangle. At the same time, a rectangular projection region will be more in line with viewing habits of human eyes, and the viewing effect will be better. Therefore, the largest rectangular region determined in the second connected region can include the screen 21, which is advantageous to further define the middle region of the screen 21.

S850: Determining a to-be-projected region in the first rectangular region according to a preset length-to-width ratio.

In some embodiments, the preset length-to-width ratio can be set according to length and width parameters of the screen 21, or user requirements, or viewing effects. For example, the preset length-to-width ratio can be 16:9, or the preset length-to-width ratio can be 4:3. It should be noted that the length and width in embodiments of the present disclosure are used to indicate the two adjacent sides of the first rectangular region. The length and the width can also be referred to as the width and the height, and the preset length-to-width ratio in embodiments of the present disclosure can also be referred to as a preset height-to-width ratio.

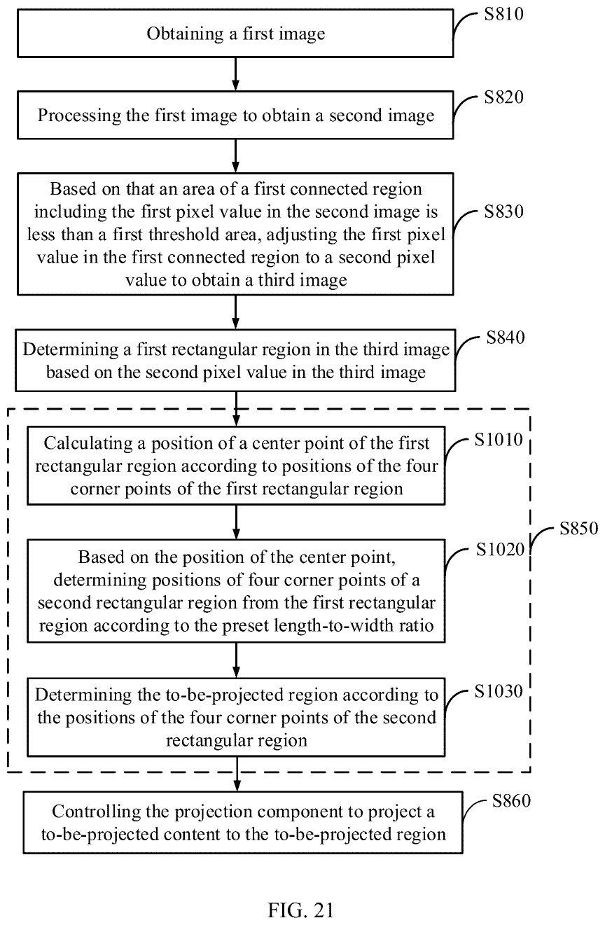

In some embodiments, as shown in FIG. 21, the step S850 in which the to-be-projected region in the first rectangular region is determined according to the preset length-to-width ratio includes S1010-S1030.

S110: Calculating a position of a center point of the first rectangular region according to positions of the four corner points of the first rectangular region.

In some embodiments, after the at least one processor 50 determines the first rectangular region, corner coordinates of the four corner points of the first rectangular region (hereinafter, also referred to as the first rectangle) can be obtained. For example, the coordinates of the four corner points of the first rectangle can be represented as A (x1, Y1), B (x1, Y2), C (x2, Y1), D (x2, Y2), respectively.

A coordinate of the center point of the first rectangle can be calculated according to the coordinates of the four corner points of the first rectangle. For example, the coordinate of the center point of the first rectangle is O (X3, y3), then the coordinate of the center point of the first rectangle is: X3=(x1+x2)/2, Y3=(Y1+Y2)/2, i.e., O ((x1+x2)/2, (Y1+Y2)/2).

S1020: Based on the position of the center point, determining positions of four corner points of a second rectangular region from the first rectangular region according to the preset length-to-width ratio.

In some embodiments, a position of a center point of the second rectangular region is the same as the position of the center point of the first rectangular region. A length-to-width ratio of the second rectangular region is the preset length-to-width ratio.

That is, after a coordinate of the center point of the first rectangular region is determined, a coordinate of the center point of the second rectangular region is determined. The center point of the first rectangular region is taken as the center point of the second rectangular region, the preset length-to-width ratio is taken as the length-to-width ratio of the second rectangular region, to determine the second rectangular region (hereinafter also refer to as a second rectangle). At that same time, corner coordinates of the four corner points of the second rectangular region are determined.

A length (or width) of the first rectangle is W1=x2−x1, and a width (or height) of the first rectangle is H1=y2−y1. When a length of the second rectangle is W2 and a width of the second rectangle is H2, the preset length-to-width ratio is 16:9 for example, that is, W2/H2=16:9.

When W1/H1>16/9, W2=H1×(16/9) and H2=H1. When W1/H1<16/9, H2=W1×(9/16) and W2=W1.

The coordinates of the four corner points of the second rectangle can be expressed as: E(X3−W2/2,y3−H2/2), F(X3+W2/2,y3−H2/2), G(X3+W2/2,y3+H2/2), H(x3−W2/2,y3+H2/2).

S1030: Determining the to-be-projected region according to the positions of the four corner points of the second rectangular region.

After the coordinates of the four corner points of the second rectangle are determined, the to-be-projected region can be determined according to the coordinates of the four corner points of the second rectangle.

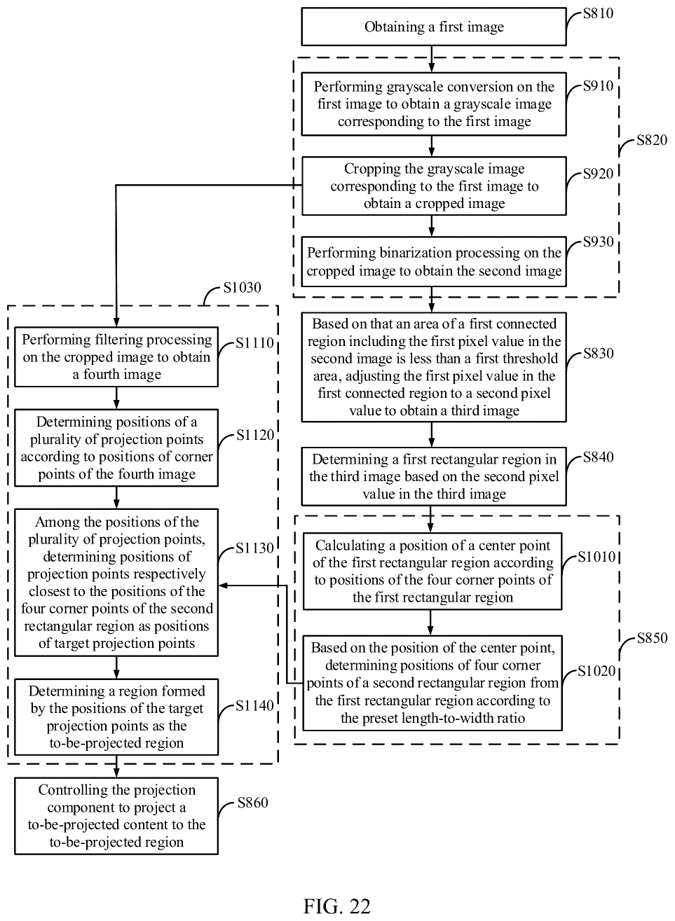

In some embodiments, as shown in FIG. 22, after the cropped image is obtained in step S920, following steps S1110 to S1140 are included.

S1110: Performing filtering processing on the cropped image to obtain a fourth image.

After the step S920 in the above embodiment is completed, filtering processing can also be performed on the cropped image. For example, mean filtering processing is performed on the cropped image. The mean filtering processing can realize smoothing processing of the cropped image to avoid influence of irrelevant corner points in the cropped image. The image after the filtering processing is the fourth image.

S1120: Determining positions of a plurality of projection points according to positions of corner points of the fourth image.

In some embodiments, after the fourth image is obtained, a corner detection method can be used to determine positions of a plurality of projection points in the fourth image. For example, the OpenCV function can be used to obtain coordinates of corner points in the fourth image. The coordinates of the corner points are the coordinates of the plurality of projection points in the projection region of the projection apparatus. That is, the projection region of the projection apparatus can be determined based on the coordinates of the plurality of projection points. The projection apparatus needs to project a to-be-projected image to the projection region.

S1130: Among the positions of the plurality of projection points, determining positions of projection points respectively closest to the positions of the four corner points of the second rectangular region as positions of target projection points.

After the coordinates of the plurality of projection points in the fourth image are determined and the coordinates of the four corner points of the second rectangular region are obtained through the step S1020, when there are coordinates, in the coordinates of the plurality of projection points, overlapping with the coordinates of the four corner points of the second rectangular region, the coordinates overlapping with the coordinates of the four corner points of the second rectangular region in the coordinates of the plurality of projection points are determined as coordinates of target projection points. When the coordinates of the plurality of projection points do not overlap with the coordinates of the four corner points of the second rectangular region, coordinates of projection points respectively closest to the coordinates of the four corner points of the second rectangular region can be determined as positions of target projection points.

For example, a traversal method can be used for the coordinates of a plurality of projection points, to determine the coordinates of the projection points overlapping with the coordinates of the four corner points of the second rectangular region, or, determine coordinates of projection points closest to the coordinates of the four corner points of the second rectangular region.

S1140: Determining a region formed by the positions of the target projection points as the to-be-projected region.

The region formed by the coordinates of the target projection points is the to-be-projected region, that is, the coordinates of the target projection points are coordinates of four corner points of the to-be-projected region.

S860: Controlling the projection component to project a to-be-projected content to the to-be-projected region.

After determining the to-be-projected region, the at least one processor 50 can control the projection component 70 to project a to-be-projected image onto the screen 21, or, the at least one processor 50 can control the projection component 70 to project a to-be-projected image to the to-be-projected region.

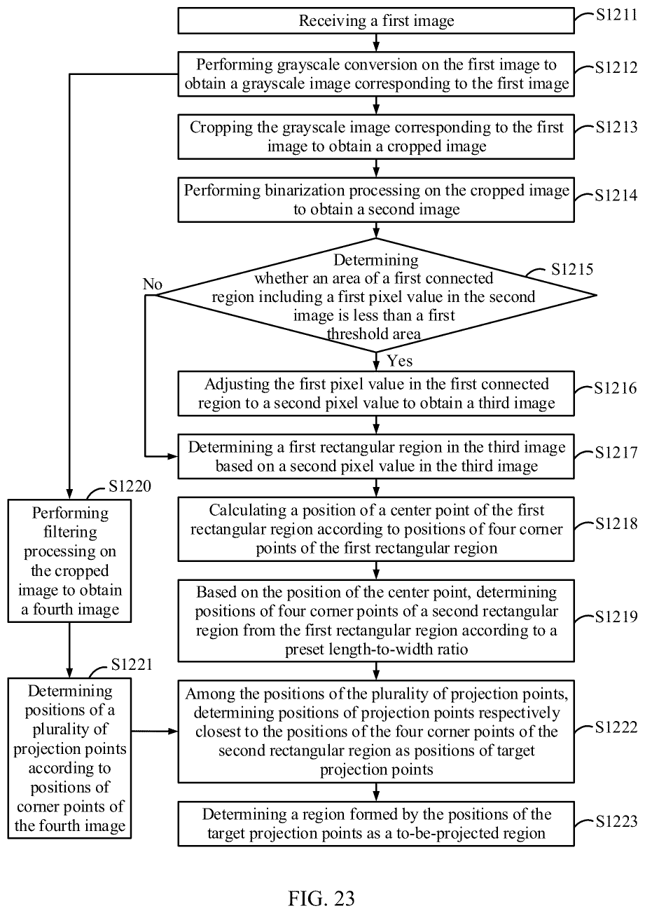

FIG. 23 is a flowchart of a projection method according to embodiments of the present disclosure. As shown in FIG. 23, the projection method can further include following steps.

S1211: Receiving a first image, where the first image is an image of a region where a screen 21 is located.

S1212: Performing grayscale conversion on the first image to obtain a grayscale image corresponding to the first image.

After step S1212 is performed, step S1213 and step S1220 can be continued to be performed respectively. Step S1213 can be performed simultaneously with step S1220, and step S1231 can be performed before or after step S1220. The performing sequence of step S1213 and step S1220 is not limited in the present disclosure.

S1213: Cropping the grayscale image corresponding to the first image to obtain an cropped image.

S1214: Performing binarization processing on the cropped image to obtain a second image.

S1215: Determining whether an area of a first connected region including a first pixel value in the second image is less than a first threshold area. When the area of the first connected region is less than the first threshold area, step S1216 is performed. When the area of the first connected region is greater than or equal to the second threshold area, step S1217 is performed.

S1216: Adjusting the first pixel value in the first connected region to a second pixel value to obtain a third image.

S1217: Determining a first rectangular region in the third image based on a second pixel value in the third image; where the first rectangular region is a largest rectangular region including the second pixel value in the third image.

S218: Calculating a position of a center point of the first rectangular region according to positions of four corner points of the first rectangular region.

S1219: Based on the position of the center point, determining positions of four corner points of a second rectangular region from the first rectangular region according to a preset length-to-width ratio. After step S1219, step S1222 is continued to be performed.

S1220: Performing filtering processing on the cropped image to obtain a fourth image.

It should be noted that step S1220 can be performed at any time between step S1212 and step S1222.

S1221: Determining positions of a plurality of projection points according to positions of corner points of the fourth image.

S1222: Among the positions of the plurality of projection points, determining positions of projection points respectively closest to the positions of the four corner points of the second rectangular region as positions of target projection points.

S1223: Determining a region formed by the positions of the target projection points as a to-be-projected region.

In some embodiments, step S860 further includes: comparing an area of the to-be-projected region with a second threshold area; based on that the area of the to-be-projected region is greater than or equal to the second threshold area, controlling the projection component 70 to project the to-be-projected content to the to-be-projected region.

By comparing the area of the to-be-projected region (which can also be referred to as the area of the screen 21) with the second threshold area, a rate of overlapping of the projection region of the projection apparatus with the screen 21 can be indicated, or, in other words, a rate of coverage of the projection region of the projection apparatus on the screen 21. When the area of the screen 21 is greater than or equal to the second threshold area, it indicates that the projection region of the projection apparatus can cover a region of the screen 21 well. In this case, it indicates that the projection apparatus enters the screen successfully. The projection component 70 can project a to-be-projected image onto the screen 21 well. When the area of the screen 21 is less than the second threshold area, it indicates that the projection region of the projection apparatus cannot cover the region of the screen 21 well. In this case, it indicates that the projection apparatus fails to enter the screen, and the projection apparatus needs to re-enter correction or other operations to achieve further projection.

In some embodiments, setting of the second threshold area is related to a device type of the projection apparatus. For example, for better viewing, the second threshold area can be set to 85% of the maximum projection region of the projection apparatus. It should be noted that the second threshold area can also be set according to actual requirements, which is not limited in embodiments of the present disclosure.

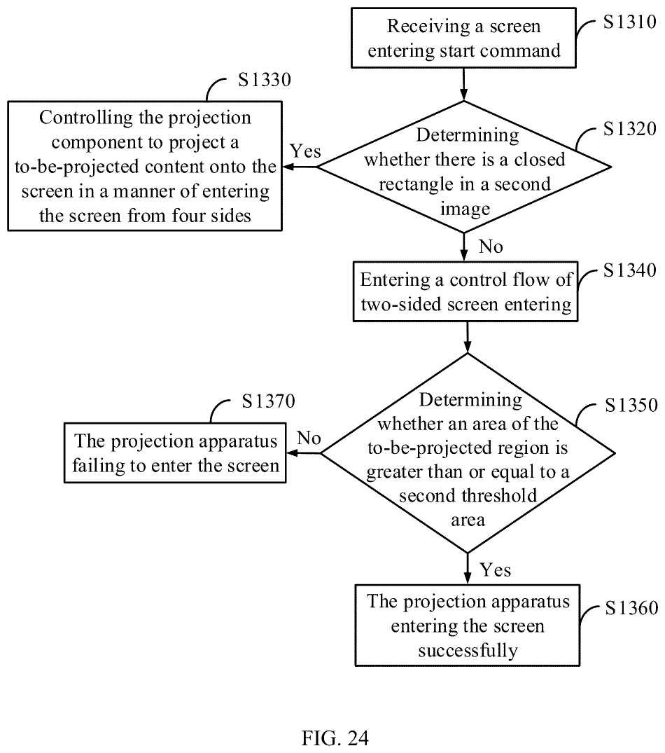

FIG. 24 is a flowchart of another projection method according to embodiments of the present disclosure. As shown in FIG. 24, the projection method includes following steps.

S1310: Receiving a screen entering start command.

For example, the projection apparatus can be provided with a screen entering switch. The screen entering switch can be a push-button switch, or, the screen entering switch can also be a touch switch, which is not limited in embodiments of the present disclosure. When a user triggers the screen entering switch, the screen entering switch sends a screen entering start command to the at least one processor 50. The at least one processor 50 receives the screen entering start command.

S1320: Determining whether there is a closed rectangle in a second image.

For example, the second image can be obtained by performing steps S1211 to S1214 in the above embodiment. By determining whether there is a closed rectangle in the second image, a condition of the border 212 of the screen 21 can be obtained. For example, whether the screen 21 is a four-sided screen or a two-sided screen can be determined.

When the second image has a closed rectangle, step S1330 is performed. When the second image does not have a closed rectangle, step S1340 is performed.

S1330: Controlling the projection component to project a to-be-projected content onto the screen in a manner of entering the screen from four sides.

When there is a closed rectangle in the second image, it indicates that the screen 21 is a four-sided screen. In this case, projection can be performed according to a projection mode of a four-sided screen.

S1340: Entering a control flow of two-sided screen entering.

In this case, the at least one processor 50 can perform the steps S810 to S860 in the above embodiments to obtain the to-be-projected region.

S1350: Determining whether an area of the to-be-projected region is greater than or equal to a second threshold area.

When the area of the to-be-projected region is greater than or equal to the second threshold area, step S1360 is performed. When the area of the to-be-projected region is less than the second threshold area, step S1370 is performed.

S1360: The projection apparatus entering the screen successfully.

S1370: The projection apparatus failing to enter the screen.

According to the projection apparatus and the projection method according to embodiments of the present disclosure, after the first image taken by the camera device is received, the first image is processed to obtain the second image in which the pixel value of each pixel is the first pixel value or the second pixel value; then, a relationship between the area of the first connected region including the first pixel value in the second image and the first threshold area is determined, when the area of the first connected region is less than the first threshold area, the first pixel value in the first connected region is adjusted to the second pixel value to obtain the third image; a first rectangular region in the third image is then determined based on the second pixel value in the third image, the first rectangular region is the largest rectangular region including the second pixel value in the third image; the to-be-projected region in the first rectangular region is determined according to the preset length-to-width ratio; and finally, the projection component is controlled to project the to-be-projected content to the to-be-projected region. Therefore, the projection apparatus can more accurately identify the screen, so that the to-be-projected content can be more accurately projected to the screen. Meanwhile, the projection apparatus according to the present disclosure has higher universality to the screen.

The foregoing description has been made with reference to specific embodiments for ease of explanation. The above discussion of some embodiment, however, is not intended to be exhaustive or to limit embodiments to the specific forms disclosed in the present disclosure. Many modifications and variations are possible in light of the above teachings. Embodiments are chosen and described in order to best explain principles and practical applications, to enable one of ordinary skilled in the art to better utilize embodiments and various variations of embodiments suitable for specific usage considerations.

What is claimed is:

1. A projection apparatus, comprising:
a projection component, configured to project a projection content onto a screen;
a camera device, configured to take an image of the screen; and
at least one processor, in connection with the camera device and the projection component respectively, wherein the at least one processor is configured to execute instructions to cause the display apparatus to:
in response to a projection command input from a user, control the projection component to project a first graphic card onto the screen, and obtain a first image taken by the camera device for the first graphic card;
cut the first graphic card in the first image to obtain a first graphic card image;
perform binarization processing on the first graphic card image, and obtain a white connected region in the first graphic card image based on a binarization result;
position a to-be-projected region based on the white connected region; and
control the projection component to project a to-be-projected content to the to-be-projected region.

2. The projection apparatus according to claim 1, wherein the at least one processor is further configured to execute instructions to cause the projection apparatus to:
calculate an area of the first graphic card image and an area of the white connected region based on detecting one white connected region;
based on that the area of the first graphic card image is equal to the area of the white connected region, determine the white connected region as the to-be-projected region.

3. The projection apparatus according to claim 1, wherein the at least one processor is further configured to execute instructions to cause the projection apparatus to:
based on detecting one white connected region, calculate an area of the first graphic card image and an area of the white connected region;
based on that the area of the first graphic card image is equal to the area of the white connected region, cut the white connected region according to a first ratio and a second ratio respectively to obtain a first region and a second region;
calculate an area of the first region and an area of the second region, and calculate an area difference between the area of the first region and the area of the second region;
based on that the area difference is less than or equal to a preset area difference threshold, determine the first region or the second region as the to-be-projected region;
based on that the area difference is greater than the preset area difference threshold, determine a region with a largest area in the first region and the second region as the to-be-projected region.

4. The projection apparatus according to claim 3, wherein the at least one processor is further configured to execute instructions to cause the projection apparatus to:
based on that the area of the first graphic card image is greater than the area of the white connected region, obtain an edge of a black connected region in the first graphic card image;
obtain a maximum rectangle to be formed by the edge in the white connected region, and determine the maximum rectangle as the to-be-projected region.

5. The projection apparatus according to claim 1, wherein the at least one processor is further configured to execute instructions to cause the projection apparatus to:
based on detecting two white connected regions, obtain a quantity of corner points of each of the two white connected regions;
based on that the quantity of the corner points of each of the two white connected regions is a preset value, obtain areas of the two white connected regions, and determine the white connected region with a largest area as a target white connected region; obtain the to-be-projected region based on the target white connected region;
based on that the quantity of the corner points of only one of the two white connected regions is the preset value, determine the white connected region with the quantity of the corner points being the preset value as the to-be-projected region.

6. The projection apparatus according to claim 5, wherein the at least one processor is further configured to execute instructions to cause the projection apparatus to:
obtain a target ratio of the target white connected region;
calculate a first error between the target ratio and a first ratio, and calculate a second error between the target ratio and a second ratio;
based on that the first error and/or the second error are less than or equal to a preset error threshold, determine the target white connected region as the to-be-projected region;
based on that the first error and the second error are both greater than the preset error threshold, cut the target white connected region according to the first ratio and the second ratio respectively, to obtain a third region and a fourth region; determine a region with a largest area in the third region and the fourth region as the to-be-projected region.

7. The projection apparatus according to claim 1, wherein the at least one processor is further configured to execute instructions to cause the projection apparatus to:
based on detecting three or more white connected regions, obtain a positional relationship between the white connected regions;
based on the positional relationship, determine the white connected region in a middle position as the to-be-projected region.

8. The projection apparatus according to claim 1, wherein the at least one processor is further configured to execute instructions to cause the projection apparatus to:
control the projection component to project a second graphic card onto the screen, and obtain a second image taken by the camera device for the second graphic card, wherein the second graphic card comprises a feature point;
obtain a mapping relationship between a content projected by the projection component and the screen based on the second image;
obtain position information of the to-be-projected region based on the mapping relationship;
control the projection component to project the to-be-projected content to the to-be-projected region based on the position information.

9. The projection apparatus according to claim 8, wherein the at least one processor is further configured to execute instructions to cause the projection apparatus to:
obtain a first coordinate of the feature point of the second graphic card under an image coordinate system corresponding to the second image;
obtain a second coordinate of the feature point under a camera device coordinate system based on the first coordinate;
convert the second coordinate into a third coordinate of the feature point under a projection component coordinate system;
obtain a projection plane equation of the screen under the projection component coordinate system based on the third coordinate;
obtain a transformation matrix of the projection component coordinate system and a world coordinate system based on the projection plane equation, wherein the transformation matrix is used for representing the mapping relationship.

10. The projection apparatus according to claim 1, wherein the at least one processor is further configured to execute instructions to cause the projection apparatus to:
adjust a projection angle of the projection component to a maximum angle.

11. A projection method for a projection apparatus, wherein the projection apparatus comprises a projection component, a camera device and at least one processor, the projection method comprises:
in response to a projection command input from a user, controlling the projection component to project a first graphic card onto a screen, and obtaining a first image taken by the camera device for the first graphic card;
cutting the first graphic card in the first image to obtain a first graphic card image;
performing binarization processing on the first graphic card image, and obtaining a white connected region in the first graphic card image based on a binarization result;
positioning a to-be-projected region based on the white connected region; and
controlling the projection component to project a to-be-projected content to the to-be-projected region.

12. The projection method according to claim 11, wherein the method further comprises:
calculating an area of the first graphic card image and an area of the white connected region based on detecting one white connected region;
based on that the area of the first graphic card image is equal to the area of the white connected region, determining the white connected region as the to-be-projected region.

13. The projection method according to claim 11, wherein the method further comprises:
based on detecting one white connected region, calculating an area of the first graphic card image and an area of the white connected region;
based on that the area of the first graphic card image is equal to the area of the white connected region, cutting the white connected region according to a first ratio and a second ratio respectively to obtain a first region and a second region;
calculating an area of the first region and an area of the second region, and calculating an area difference between the area of the first region and the area of the second region;
based on that the area difference is less than or equal to a preset area difference threshold, determining the first region or the second region as the to-be-projected region;
based on that the area difference is greater than the preset area difference threshold, determining a region with a largest area in the first region and the second region as the to-be-projected region.

14. The projection method according to claim 13, wherein the method further comprises:
based on that the area of the first graphic card image is greater than the area of the white connected region, obtaining an edge of a black connected region in the first graphic card image;
obtaining a maximum rectangle to be formed by the edge in the white connected region, and determining the maximum rectangle as the to-be-projected region.

15. The projection method according to claim 11, wherein the method further comprises:
based on detecting two white connected regions, obtaining a quantity of corner points of each of the two white connected regions;
based on that the quantity of the corner points of each of the two white connected regions is a preset value, obtaining areas of the two white connected regions, and determining the white connected region with a largest area as a target white connected region; obtaining the to-be-projected region based on the target white connected region;
based on that the quantity of the corner points of only one of the two white connected regions is the preset value, determining the white connected region with the quantity of the corner points being the preset value as the to-be-projected region.

16. The projection method according to claim 15, wherein the method further comprises:
obtaining a target ratio of the target white connected region;
calculating a first error between the target ratio and a first ratio, and calculating a second error between the target ratio and a second ratio;
based on that the first error and/or the second error are less than or equal to a preset error threshold, determining the target white connected region as the to-be-projected region;
based on that the first error and the second error are both greater than the preset error threshold, cutting the target white connected region according to the first ratio and the second ratio respectively, to obtain a third region and a fourth region; determining a region with a largest area in the third region and the fourth region as the to-be-projected region.

17. The projection method according to claim 11, wherein the method further comprises:
based on detecting three or more white connected regions, obtaining a positional relationship between the white connected regions;
based on the positional relationship, determining the white connected region in a middle position as the to-be-projected region.

18. The projection method according to claim 11, wherein the method further comprises:
controlling the projection component to project a second graphic card onto the screen, and obtain a second image taken by the camera device for the second graphic card, wherein the second graphic card comprises a feature point;
obtaining a mapping relationship between a content projected by the projection component and the screen based on the second image;
obtaining position information of the to-be-projected region based on the mapping relationship;
controlling the projection component to project the to-be-projected content to the to-be-projected region based on the position information.

19. The projection method according to claim 18, wherein the method further comprises:
obtaining a first coordinate of the feature point of the second graphic card under an image coordinate system corresponding to the second image;
obtaining a second coordinate of the feature point under a camera device coordinate system based on the first coordinate;
converting the second coordinate into a third coordinate of the feature point under a projection component coordinate system;
obtaining a projection plane equation of the screen under the projection component coordinate system based on the third coordinate;
obtaining a transformation matrix of the projection component coordinate system and a world coordinate system based on the projection plane equation, wherein the transformation matrix is used for representing the mapping relationship.

20. The projection method according to claim 11, wherein the method further comprises:
adjusting a projection angle of the projection component to a maximum angle.
